(19) United States
(12) Patent Application Publication
(10) Pub. No.: US 2011/0123728 A1
(43) Pub. Date: May 26, 2011

(54) THIN FILM MANUFACTURING METHOD AND THIN FILM ELEMENT

(75) Inventors: Eiichi OHTA, Kanagawa (JP); Masahiro Yagi, Kanagawa (JP)

(73) Assignee: RICOH COMPANY, LTD., Tokyo (JP)

(21) Appl. No.: 12/952,241

(22) Filed: Nov. 23, 2010

(30) Foreign Application Priority Data
Nov. 25, 2009 (JP) NO.2009-267905
Nov. 25, 2009 (JP) NO.2009-267906
Nov. 25, 2009 (JP) NO.2009-267907

(51) Int. Cl. B05D 3/06; B05D 3/02

(52) U.S. Cl. 427/595; 427/372.2; 427/256

(57) ABSTRACT

A thin film manufacturing method includes the steps of a) placing a substrate including a first main surface inside a reaction container filled with a raw material solution, and b) forming a thin film by irradiating a light in the direction of the first main surface of the substrate.

### BACKGROUND OF THE INVENTION

1. Field of the Invention

The present invention relates to a thin film manufacturing method and a thin film element.

2. Description of the Related Art

Conventionally, a chemical solution deposition method (CSD method) is known as a method for forming an element such as a piezoelectric element. With the CSD method, a thin film is formed on the surface of a substrate by coating the substrate with a raw solution and drying the raw solution. As one example, Japanese Patent No. 4108502 discloses a method for forming a dielectric thin film by using a metal oxide precursor solution containing a metal oxide precursor and a dye.

However, with the CSD method, the processes of applying and drying the coating of the metal oxide precursor solution require a significantly large workload and lead to high manufacturing cost. Further, the thin film tends to crack in the drying process.

### SUMMARY OF THE INVENTION

The present invention may provide a thin film manufacturing method and a thin film element that substantially eliminate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a thin film manufacturing method and a thin film element particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a thin film manufacturing method including the steps of: a) placing a substrate including a first main surface inside a reaction container filled with a raw material solution; and b) forming a thin film by irradiating a light in the direction of the first main surface of the substrate.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating a thin film manufacturing method according to a first embodiment of the present invention;

FIG. 2 is a schematic diagram illustrating a thin film pattern according to an embodiment of the present invention;

FIG. 3 is a schematic diagram for describing positions of irradiation targets of first and second light sources according to an embodiment of the present invention;

FIG. 4 is a schematic diagram for describing a first modified example of the thin film manufacturing method according to the first embodiment of the present invention;

FIG. 5 is a schematic diagram for describing a method of irradiating a laser beam from a side towards a substrate according to an embodiment of the present invention;

FIG. 6 is a schematic diagram for describing a thin film manufacturing method according to a second embodiment of the present invention;

FIG. 7 is a schematic diagram illustrating a multilayer film formed by the thin film manufacturing method according to the second embodiment of the present invention;

FIG. 8 is a schematic diagram illustrating a thin film manufacturing method according to a third embodiment of the present invention;

FIG. 9 is a schematic diagram illustrating a thin film pattern according to another embodiment of the present invention;

FIG. 10 is a schematic diagram illustrating a piezoelectric element having an active layer (piezoelectric film) formed by the thin film manufacturing method according to the third embodiment of the present invention;

FIG. 11 is a schematic diagram illustrating a first modified example of the thin film manufacturing method according to the third embodiment of the present invention;

FIG. 12 is a schematic diagram illustrating a thin film pattern formed on a first main surface of an electrode layer according to an embodiment of the present invention;

FIG. 13 illustrates a fourth modified example of the thin film manufacturing method according to the third embodiment of the present invention;

FIG. 14 is a schematic diagram illustrating a thin film manufacturing method according to a fourth embodiment of the present invention;

FIG. 15 illustrates a third modified example of the thin film manufacturing method according to the fourth embodiment of the present invention;

FIG. 16 illustrates a fourth modified example of the thin film manufacturing method according to the fourth embodiment of the present invention;

FIG. 17 is a schematic diagram illustrating a thin film manufacturing method according to a fifth embodiment of the present invention;

FIG. 18 illustrates a first modified example of the thin film manufacturing method according to the fifth embodiment of the present invention;

FIG. 19 is a second modified example of the thin film manufacturing method according to the fifth embodiment of the present invention;

FIG. 20 is a schematic diagram illustrating a thin film manufacturing method according to a sixth embodiment of the present invention;

FIG. 21 is a schematic diagram illustrating a thin film pattern according to yet another embodiment of the present invention;

FIG. 22 is a schematic diagram for describing target irradiation areas of a laser beam according to an embodiment of the present invention;

FIG. 23 is a schematic diagram illustrating a piezoelectric element having an active layer (piezoelectric film) formed by the thin film manufacturing method according to the sixth embodiment of the present invention;

FIG. 24 is a schematic diagram illustrating a first modified example of the thin film manufacturing method according to the sixth embodiment of the present invention;

FIG. 25 is a schematic diagram illustrating a thin film pattern formed on a first main surface of an electrode layer according to another embodiment of the present invention;

FIG. 26 is a schematic diagram illustrating a fourth modified example of the thin film manufacturing method according to the sixth embodiment of the present invention;

FIG. 27 is a schematic diagram illustrating a thin film manufacturing method according to a seventh embodiment of the present invention;

FIG. 28 is a schematic diagram illustrating a first modified example of the thin film manufacturing method according to the seventh embodiment of the present invention; and

FIG. 29 is a schematic diagram illustrating a thin film manufacturing method according to a eighth embodiment of the present invention.

### DETAILED DESCRIPTION OF THE PREFERRED EMBODIMENTS

### First Embodiment

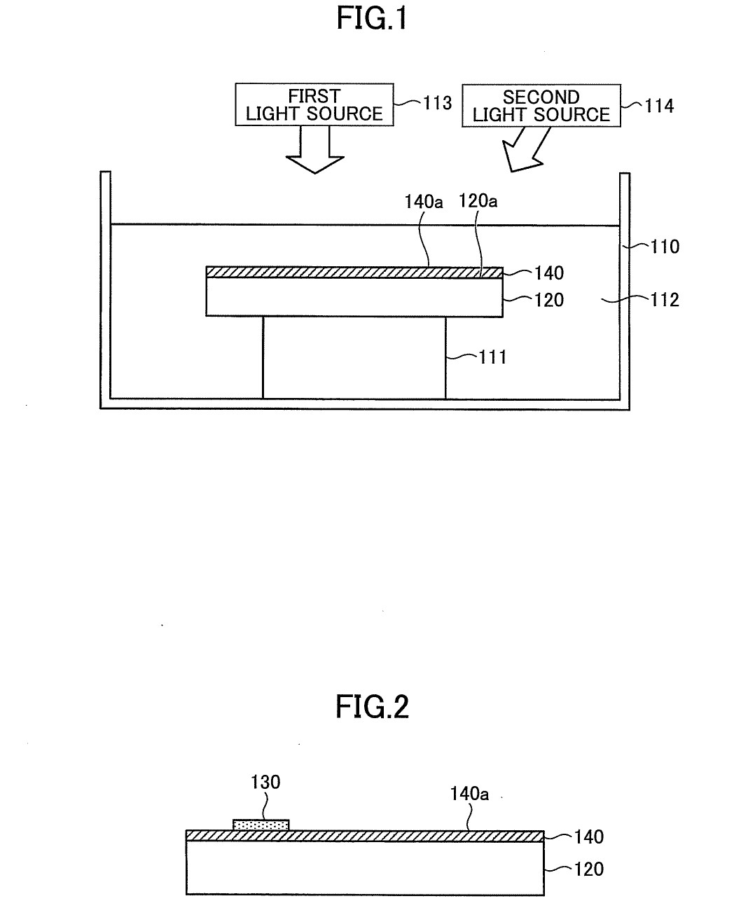

FIG. 1 is a schematic diagram illustrating a thin film manufacturing method according to a first embodiment of the present invention. In this embodiment, an example of a method for forming a thin film used for a piezoelectric element is described. As illustrated in FIG. 1, a pedestal 111 is placed in a reaction container 110. A substrate 120 on which a thin film (also referred to as a “thin film pattern”) 130 is to be formed is placed on the pedestal 111. The substrate 120 may be, for example, a silicon substrate. An electrode layer 140 is formed on a first main surface 120a of the substrate 120. The electrode layer 140 may be formed with a material having a conductive property such as platinum (Pt), a lanthanum-nickel-oxide or a strontium-ruthenium-oxide having high light transmittance. The electrode layer 140 may be formed by using, for example, a sputtering method. The electrode layer 140 may be formed on the substrate 120 in a patterned state. Although the substrate 120 of the first embodiment of the present invention is formed having the electrode layer 140 formed thereon, the substrate 120 may alternatively be formed without the electrode layer 140.

The reaction container 110 is filled with a metal oxide precursor solution 112. A first light source 113 and a second light source 114 are positioned facing towards the side of a first main surface 140a of the electrode layer 140. That is, the first light source 113 and the second light source 114 are positioned above the reaction container 110. The first and second light sources 113, 114 irradiate lasers from above the metal oxide precursor solution 112 contained in the reaction container 110. The target to be irradiated by the first light source 113 is the solvent of the metal oxide precursor solution 112 (first irradiation target). The first light source 113 directly heats the metal oxide precursor solution 112 by directly irradiating a laser to the solvent of the metal oxide precursor solution 112 (direct heating). The target to be irradiated by the second light source 114 is the first main surface 140a of the electrode layer 140 (second irradiation target). The second light source 114 indirectly heats the metal oxide precursor solution 112 by heating the substrate 120 on which the first main surface 140a of the electrode layer 140 is irradiated with a laser (indirect heating).

The substrate 120 is positioned in the reaction container 110 so that the first main surface 140a of the electrode layer 140 is positioned at a relatively shallow area of the metal oxide precursor solution 112. The substrate 120 is positioned in such manner to the extent that the irradiation position of the direct heating does not deviate from the position at which a thin film is to be formed on the first main surface 140a with respect to a vertical direction.

The first light source 113 irradiates a laser beam having a wavelength which is set, so that the light absorption rate of the main solvent of the metal oxide precursor solution 112 is equal to or more than a predetermined threshold. Preferably, the first light source 113 irradiates a laser beam having a wavelength that enables the light absorption rate of the main solvent of the metal oxide precursor solution 112 to become the highest. In this embodiment, an ethanol type organic solvent is used as the main solvent of the metal oxide precursor solution 112. In this embodiment, the wavelength of the laser beam of the first optical source 113 for attaining a high light absorption rate of the main solvent is a wavelength equal to 400 nm or less.

On the other hand, the second light source 114 irradiates a laser beam having a wavelength which is set, so that the light absorption rate of the main solvent of the metal oxide precursor solution 112 is less than the light absorption rate attained when the first light source 113 irradiates the laser beam to the main solvent of the metal oxide precursor solution 112. Preferably, the second light source 114 irradiates a laser beam having a wavelength that enables the light absorption rate of the main solvent of the metal oxide precursor solution 112 to become less than a predetermined threshold. More preferably, the second light source 114 irradiates a laser beam having a wavelength that enables the light absorption rate of the main solvent of the metal oxide precursor solution 112 to become lowest and enables the light absorption rate of the main solvent of the metal oxide precursor solution 112 to become the highest. More specifically, the wavelength of the laser beam selected for the second light source 114 is, for example, equal to or more than 400 nm. In this embodiment, the second light source 114 irradiates a laser beam having a wavelength of 1064 nm. It is to be noted that the light irradiated from the first and second light sources 113 and 114 is not limited to a laser beam.

The first and second light sources 113 and 114 are configured to irradiate laser beams to positions corresponding to each area on the first main surface 140a of the electrode layer 140. Accordingly, a thin film pattern 130 can be formed on a desired area on the first main surface 140a of the electrode layer 140.

In this embodiment, the position of the first light source 113 is controlled so that the distance (depth) from the surface of the metal oxide precursor solution 112 to the first main surface 140a of the electrode layer 140 is substantially equal to the depth of the light transmittance (light transmission depth) of the first light source 113. For example, the distance (depth) from the surface of the metal oxide precursor solution 112 to the first main surface 140a of the electrode layer 140 and the light transmission depth of the first light source 113 is approximately 10 μm.

Based on above conditions, the first and second light sources 113 and 114 irradiate laser beams to corresponding irradiation targets to form a thin film on a given area of the electrode layer 140. As illustrated in FIG. 2, in accordance with the positions of the irradiation targets irradiated by two lasers of the first and second light sources 113 and 114, a thin film pattern 130 of amorphous metal oxide or crystalline metal oxide (metal oxide thin film) obtained from the metal oxide precursor is formed on the first main surface 40a of the electrode layer 40. The timing of the irradiation by the first light source 113 and the second light source 114 may be the same or different.

By using the laser beams as a combination, maximum necessary output of the first and second light sources 113 and 114 can be reduced. Thereby, the total cost of the facility of the first and second light sources 113 and 114 can be reduced. In this embodiment, by using two light sources, the maximum necessary output of each of the first and second light sources 113 and 114 can be reduced to 20% or less.

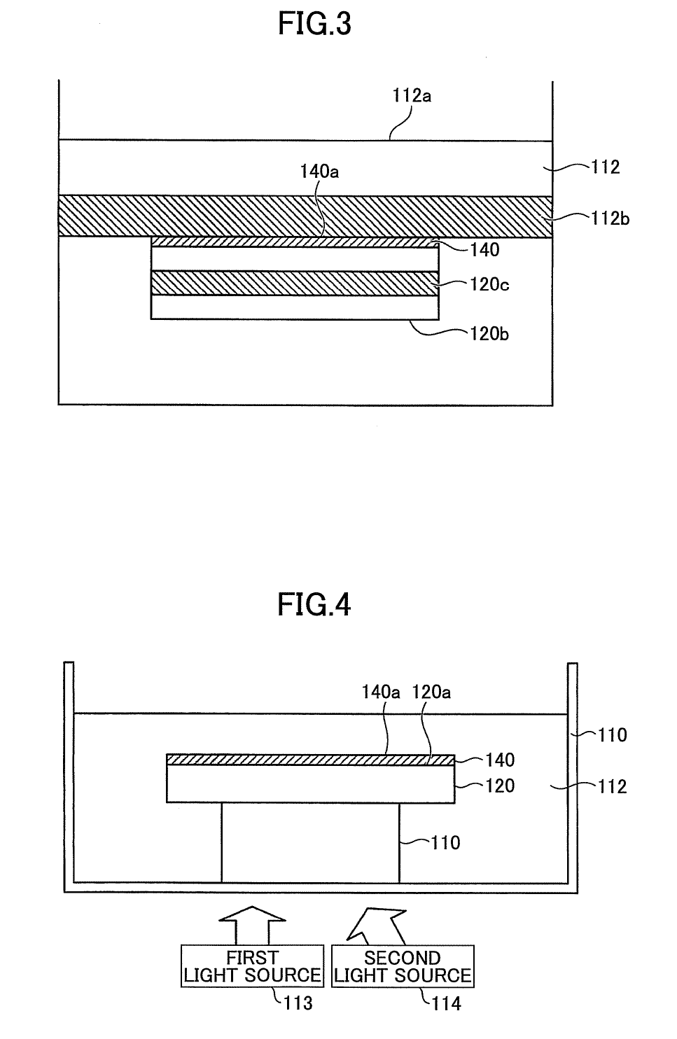

FIG. 3 is a schematic diagram for describing the positions of the irradiation targets of the first and second light sources 113 and 114 according to an embodiment of the present invention. For example, as illustrated in FIG. 3, the areas of the irradiation target of the first light source 113 (i.e. position of the irradiation target for performing direct heating) could be the surface 112a of the metal oxide precursor solution 112 and/or an inside area 112b of the metal oxide precursor solution 112 (two target irradiation areas). The position of the irradiation target of the second light source 114 (i.e. position of the irradiation target for performing indirect heating) could be the first main surface 140a of the electrode layer 140, an inner portion 120c of the substrate 120, and/or a second main surface 120b at the back of the substrate 120 (three target irradiation areas). The inner portion 120c of the substrate 120 includes an inside part of the electrode layer 140. The first and second light sources 130 and 140 may perform irradiation on any combination of the two target irradiation areas and the three target irradiation areas. The target irradiation areas and the effects of irradiation at the target irradiation areas are illustrated in the following Table 1.

TABLE 1

| | | | | | a. | | c. | d. | | f. |
|---|---|---|---|---|---|---|---|---|---|---|
| | | | | | THIN | | HIGH | HIGH | e. | SIM- |
| | | | | | FILM | | ADHESIVE- | ACCU- | SELEC- | PLIC- |
| | | | | TYPE | FORM- | b. | NESS | RACY/ | TION | ITY |
| | | | | OF | ING | SUB- | BETWEEN | HIGH | OF | OF |
| | | | | SOLU- | WITH | STRATE | SUB- | RESOLU- | SUB- | OPTI- |
| | | BEHAVIOUR OF | | TION | FEW | WITH | STRATE | TION | STRATE | CAL |
| | HEATING | OPTICAL ENERGY | | REAC- | IMPUR- | LITTLE | AND | PATTERN- | MATE- | APPA- |
| CASE | AREA | SOLUTION | SUBSTRATE | TION | ITIES | DAMAGE | FILM | ING | RIAL | RATUS |
| A | SOLUTION | ABSORB | — | DIRECT | ∘ | ∘ | x | ∘ | ∘ | x |
| | SURFACE | | | HEATING | | | | | | |
| B | INSIDE OF | ABSORB | — | DIRECT | ∘ | ∘ | x | ∘ | ∘ | x |
| | SOLUTION | | | HEATING | | | | | | |
| C | SOLUTION/ | PERMEATE | ABSORB | INDIRECT | x | x | ∘ | x | ∘ | ∘ |
| | ELECTRODE | | | HEATING | | | | | | |
| | LAYER | | | | | | | | | |
| | INTERFACE | | | | | | | | | |
| D | INNER | PERMEATE | ABSORB | INDIRECT | x | x | ∘ | x | ∘ | ∘ |
| | PORTION | | | HEATING | | | | | | |
| | OF | | | | | | | | | |
| | SUBSTRATE | | | | | | | | | |
| E | BACK | PERMEATE | ABSORB | INDIRECT | x | x | ∘ | x | ∘ | ∘ |
| | OF | | | HEATING | | | | | | |
| | SUBSTRATE | | | | | | | | | |
| | SURFACE | | | | | | | | | |

In case A, the surface of the metal oxide precursor solution 112 is the target irradiation area (i.e. heating area). In this case, optical energy is absorbed by the metal oxide precursor solution 112 and does not reach the substrate 120. In case B, an inside area of the metal oxide precursor solution 112 is the heating area. In this case also, optical energy is absorbed by the metal oxide precursor solution 112.

In case C, the interface between the metal oxide precursor solution 112 and the substrate 120, (i.e. first main surface 120a of the substrate 120) is the heating area. In case D, the inner portion 120c of the substrate 120 is the heating area. In case E, the second main surface 120b of the substrate 120 is the heating area. In the cases C, D and E, optical energy permeates (transmits) through the metal oxide precursor solution 112 and is absorbed by the substrate 120. The type of solution reaction performed in the cases C, D, and E are indirect heating in which the metal oxide precursor solution 112 is indirectly heated by heating the substrate 120.

In a case of forming a thin film with few impurities (column a in Table 1), satisfactory results can be attained in the cases A and B where direct heating is performed. In the cases A and B, the optical energy can directly cut off (disconnect) the bond between carbon and oxygen inside the metal oxide precursor solution 112. As a result, generation of residual carbon and soot can be prevented. Thereby, a high quality thin film without impurities can be manufactured. On the other hand, in the cases C, D, and E, incomplete thermal decomposition of the metal oxide precursor solution 112 tends to occur due to indirect heating. This results in the generation of residual carbon and soot.

In a case of forming a thin film with little damage (column b in Table 1), satisfactory results can be attained in the cases A and B. In the cases A and B, the damage to the substrate 120 can be controlled to a small amount because optical energy hardly reaches the substrate 120. On the other hand, in the cases C, D, and E, the substrate 120 may be thermally damaged because the substrate 120 is heated.

In a case of forming a thin film with high adhesiveness between the substrate 120 and the thin film 130 (column c in Table 1), satisfactory results can be attained in the cases C, D, and E. In the cases C, D, and E, the adhesiveness between the substrate 120 and the thin film may be increased owing to the phase change of the metal oxide precursor solution 112 occurring in the vicinity of the first main surface 120a of the substrate 120. On the other hand, in the cases A and B, the adhesiveness between the substrate 20 and the thin film becomes relatively lower due to phase change occurring at the surface 112a of the metal oxide precursor solution 112 or occurring in the inside area 112b of metal oxide precursor solution 112.

In a case of forming a thin film with high accuracy and high resolution patterning (column d in Table 1), satisfactory results can be attained in the cases A and B. In the cases A and B, patterning can be performed with high accuracy and high resolution corresponding to the spot diameter of the optical energy. On the other hand, in the cases C, D, and E, the heating area tends to broaden compared to the spot diameter of the optical energy due to the thermal characteristics of the substrate 120. Therefore, the cases C, D, and E are inferior compared to the cases A and B from the aspect of high accuracy and high resolution patterning.

From the aspect of selection of the material of the substrate 120 (column e in Table 1), all of the cases A-E are satisfactory. For example, silicon may be used as the material of the substrate 120. From the aspect of light source (column f in Table 1), the light used in the cases A and B has a short wavelength (e.g., equal to or less than 400 nm). Thus, the cases A and B require an expensive and sophisticated (difficult operability) apparatus such as a UV laser apparatus. On the other hand, the light used in the cases C, D, and E has a long wavelength (e.g., equal to or more than 400 nm). Thus, a CO₂ laser apparatus, which is relatively inexpensive and is generally suitable for performing processing, can be used in the cases C, D, and E.

Accordingly, both direct heating and indirect heating have advantages and disadvantages. With the above-described embodiment of the thin film manufacturing method, the advantages of both direct heating and indirect heating can be attained by suitably combining direct heating and indirect heating. More specifically, for example, generation of residual carbon and soot can be prevented by the direct heating (see column a in Table 1). In addition, the adhesiveness between the first main surface 140a and the thin film can be increased.

It is to be noted that other than the step process of dipping the substrate 120 in the metal oxide precursor solution 112, the processes performed for forming the thin film are substantially the same as those performed with a sol-gel method. The metal oxide precursor solution 112 is substantially the same as the metal oxide precursor solution applied onto the substrate.

After a thin film is formed inside the metal oxide precursor solution 112, the substrate 120 is cleaned when removing the substrate 120 from the metal oxide precursor solution 112. For example, ultrasonic cleaning by using a solvent or rinsing by using a solvent is performed on the substrate 120. It is preferable for the solvent to have a relatively high volatility and to have a small amount of moisture content. More specifically, the solvent may be, for example, acetone, ethanol, or IPA (Isopropyl alcohol). By using the solvent, metal alkoxide in the metal oxide precursor solution 112 can be prevented from remaining on the substrate 120 (prevention of residue on substrate 120).

After the cleaning, thermal processing is discretionally performed on the thin film formed on the substrate 120 according to the state of the thin film (mainly according to the crystallinity of the thin film). In a case where the thin film is crystalline, for the purpose of drying, the thin film is heated to the extent of not changing the shape of the crystals of the thin film. For example, the thin film is heated at a temperature of approximately 100-150° C. The heating may be discretionally performed in an appropriate atmosphere. For example, in a case where the thin film has a deliquescent property, the heating is performed in an inert gas atmosphere having little residual moisture. In a case where the thin film is non-crystalline, the thin film may not exhibit a desired function unless the material of the thin film (e.g., piezo material) is crystallized. Accordingly, in such case where the thin film is non-crystalline, the thin film is heated for the purpose of crystallizing the material of the thin film. The temperature and time for heating the thin film differs depending on the material of the thin film. For example, in a case where the material of the thin film is PZT (lead zirconate titanate), the thin film is heated at a temperature of approximately 600-800° C. for approximately 1-10 minutes.

More specifically, the metal oxide precursor may be made of a substance capable of forming a metal oxide thin film. In other words, a substance capable of forming an amorphous metal oxide or a crystalline metal oxide may be used as the substance for forming the metal oxide precursor. For example, a metal complex (e.g., a metal alcoxide, a β-diketonato complex, or a metal chelate) or a metal carboxylate may be used as the substance for forming the metal oxide precursor. For example, an ethanol type organic solvent may be used as the solvent in forming the metal oxide precursor.

The metal alcoxide may be, for example, Si, Ge, Ga, As, Sb, Bi, V, Na, Ba, Sr, Ca, La, Ti, Ta, Zr, Cu, Fe, W, Co, Mg, Zn, Ni, Nb, Pb, Li, K, Sn, Al, or Sm. Further, a metal alcoxide including an alcoxyl group (e.g., OCH₃, OC₂H₅, OC₃H₇, OC₄H₉, OC₂H₄OCH₃) may also be used.

The β-diketonato complex may be, for example, metal and acetylacetone, a benzoyl acetone, a benzoyl-trifluoroacetone, a benzoyl-difluoroacetone, and a benzoyl-fluoroacetone.

The metal carboxylate may be, for example, a barium acetate, a copper acetate (II), a lithium acetate, a magnesium acetate, a zinc acetate, a barium oxalate, a calcium oxalate, a copper oxalate (II), a magnesium oxalate, or a tin oxalate (II). An alcohol type organic solvent may be used as the solvent in forming the metal oxide precursor. The density of the solvent is preferably 0.1-1 mol/l. More preferably, the density of the solvent is 0.3-0.7 mol/l. It is to be noted that the upper limit value of the density is determined from the aspect of attaining liquid stability. The lower limit value of the density is determined from the aspect of the speed of depositing the thin film.

In this embodiment, because a laser beam is irradiated to the substrate 120 being in a state dipped inside the metal oxide precursor solution 112, a thin film is formed only at a portion of the substrate 120 on which the laser beam is irradiated. Accordingly, steps performed in a conventional sol-gel method such as a step of adding and drying a metal oxide precursor solution and a step of dry-etching or wet-etching for removing the metal oxide solution can be omitted. These steps of the conventional sol-gel method generate a significant amount of manufacturing cost. Therefore, because these steps can be omitted by using the thin film manufacturing method according to an embodiment of the present invention, manufacturing cost can be significantly reduced.

Further, because thin film formation reaction occurs inside the metal oxide precursor solution 112, the metal oxide precursor solution 112 is constantly being supplied during the thin film formation reaction. Therefore, cracks can be prevented from being created in the thin film.

The thin film formed by the thin film manufacturing method according to an embodiment of the present invention may be used as, for example, an ultrasonic piezoelectric element, a non-volatile memory element (e.g., FET), or an actuator element. More specifically, the actuator element may be used for, for example, a recording head of an inkjet printer.

FIG. 4 is a schematic diagram for describing a first modified example of the thin film manufacturing method according to the first embodiment of the present invention. In the first modified example, the first and second light sources 113 and 114 are positioned towards the side of the second main surface 120b of the substrate 120 (opposite side of the first main surface 120a of the substrate 120). With the first modified example, laser beams are irradiated from the side of the second main surface 120b because the first and second light sources 113 and 114 are positioned towards the side of the second main surface 120b as illustrated in FIG. 4. In a similar manner to that of the first embodiment of the present invention illustrated in FIGS. 1 and 2, a thin film is formed on the first main surface 120a by heating the metal oxide precursor solution 112 or the vicinity of the first main surface 140a of the electrode layer 140. It is to be noted that the substrate 120, the electrode layer 140, the pedestal 111, and the reaction container 110 of the modified example are formed of a material that allows the light from the first and second light sources 113 and 114 to permeate (transmit) therethrough.

With reference to FIG. 3, the areas of the irradiation target of the first light source 113 (i.e. positions of irradiation target for performing direct heating) according to the first modified example could be the surface 112a of the metal oxide precursor solution 112, the inside area 112b of the metal oxide precursor solution 112, and/or the first main surface 140a of the electrode layer 140 (three target irradiation areas). The positions of the irradiation target of the second light source 114 (i.e. positions of irradiation target for performing indirect heating) according to the first modified example could be the inner portion 120c of the substrate 120 and the second main surface 120b at the back of the first main surface 120a (opposite side of the first main surface 120a) of the substrate 120 (two target irradiation areas). The target irradiation areas and the effects of irradiation at the target irradiation areas are illustrated in the following Table 2.

TABLE 2

| | | | | | a. | | c. | d. | | f. |
|---|---|---|---|---|---|---|---|---|---|---|
| | | | | | THIN | | HIGH | HIGH | e. | SIM- |
| | | | | | FILM | | ADHESIVE- | ACCU- | SELEC- | PLIC- |
| | | | | TYPE | FORM- | b. | NESS | RACY/ | TION | ITY |
| | | | | OF | ING | SUB- | BETWEEN | HIGH | OF | OF |
| | | | | SOLU- | WITH | STRATE | SUB- | RESOLU- | SUB- | OPTI- |
| | | BEHAVIOUR OF | | TION | FEW | WITH | STRATE | TION | STRATE | CAL |
| | HEATING | OPTICAL ENERGY | | REAC- | IMPUR- | LITTLE | AND | PATTERN- | MATE- | APPA- |
| CASE | AREA | SOLUTION | SUBSTRATE | TION | ITIES | DAMAGE | FILM | ING | RIAL | RATUS |
| F | SOLUTION | ABSORB | PERMEATE | DIRECT | ∘ | Δ | x | ∘ | x | x |
| | SURFACE | | | HEATING | | | | | | |
| G | INSIDE OF | ABSORB | PERMEATE | DIRECT | ∘ | Δ | x | ∘ | x | x |
| | SOLUTION | | | HEATING | | | | | | |
| H | SOLUTION/ | ABSORB | PERMEATE | DIRECT | ∘ | Δ | ∘ | ∘ | x | x |
| | ELECTRODE | | | HEATING | | | | | | |
| | LAYER | | | | | | | | | |
| | INTERFACE | | | | | | | | | |
| I | INNER | — | ABSORB | INDIRECT | x | x | ∘ | x | ∘ | ∘ |
| | PORTION | | | HEATING | | | | | | |
| | OF | | | | | | | | | |
| | SUBSTRATE | | | | | | | | | |
| J | BACK | — | ABSORB | INDIRECT | x | x | ∘ | x | ∘ | ∘ |
| | OF | | | HEATING | | | | | | |
| | SUBSTRATE | | | | | | | | | |
| | SURFACE | | | | | | | | | |

In cases F, G, and H, optical energy permeates (transmits) through the substrate 120 and is absorbed by the metal oxide precursor solution 112. The type of solution reaction performed in the cases F, G, and H is direct heating. In cases I and J, optical energy is absorbed by the substrate 120. The type of solution reaction performed in the cases I and J is indirect heating.

In a case of forming a thin film with few impurities (column a in Table 2), satisfactory results can be attained in the cases F, G, and H where direct heating is performed. However, impurities may be generated in the case H because a part of the laser beam is absorbed by the metal oxide precursor solution 112 before the laser beam reaches the first main surface 140a of the electrode surface 140. Therefore, from the aspect of forming a thin film with few impurities, the case H is inferior compared to the cases F and G.

In a case of forming a thin film with little damage (column b in Table 2), the substrate 120 may be damaged in the cases F, G, and H due to a portion of the optical energy being converted into thermal energy when the laser beam permeates (transmits) through the substrate 120. Therefore, with respect to the aspect of forming a thin film with little damage, the cases F, G, and H may be inferior compared to the above-described cases A and B. However, the cases F, G, and H are superior compared to the cases I and J.

In a case of forming a thin film with high adhesiveness between the substrate 120 and the thin film 130 (column c in Table 2), satisfactory results can be attained in the cases H, I, and J. In the cases H, I, and J, the adhesiveness between the substrate 120 and the thin film 130 may be increased owing to the phase change of the metal oxide precursor solution 112 occurring in the vicinity of the interface between the substrate 120 and the thin film 130. In a case of forming a thin film with high accuracy and high resolution patterning (column d in Table 2), satisfactory results can be attained in the cases F, G, and H. From the aspect of selection of the material of the substrate 120 (column e in Table 2), satisfactory results can be attained in the cases I and J where the substrate 120 is heated. On the other hand, the results are unsatisfactory in the cases F, G, and H. That is, only a few kinds of materials can be selected as the material of the substrate 120 because optical energy is required to permeate (transmit) through the substrate 120 in the cases F, G, and H.

From the aspect of light source (column f in Table 2), an expensive and sophisticated apparatus that irradiates a laser beam of a short wavelength is required in the cases F, G, and H. On the other hand, a relatively inexpensive apparatus, which irradiates a laser beam of a long wavelength and is generally suitable for performing processing, can be used in the cases I and J.

Accordingly, in the above-described first modified example, a thin film can also be formed on the first main surface by irradiating a laser beam from the side of the substrate 120 instead of irradiating a laser beam from the side of the metal oxide precursor solution 112.

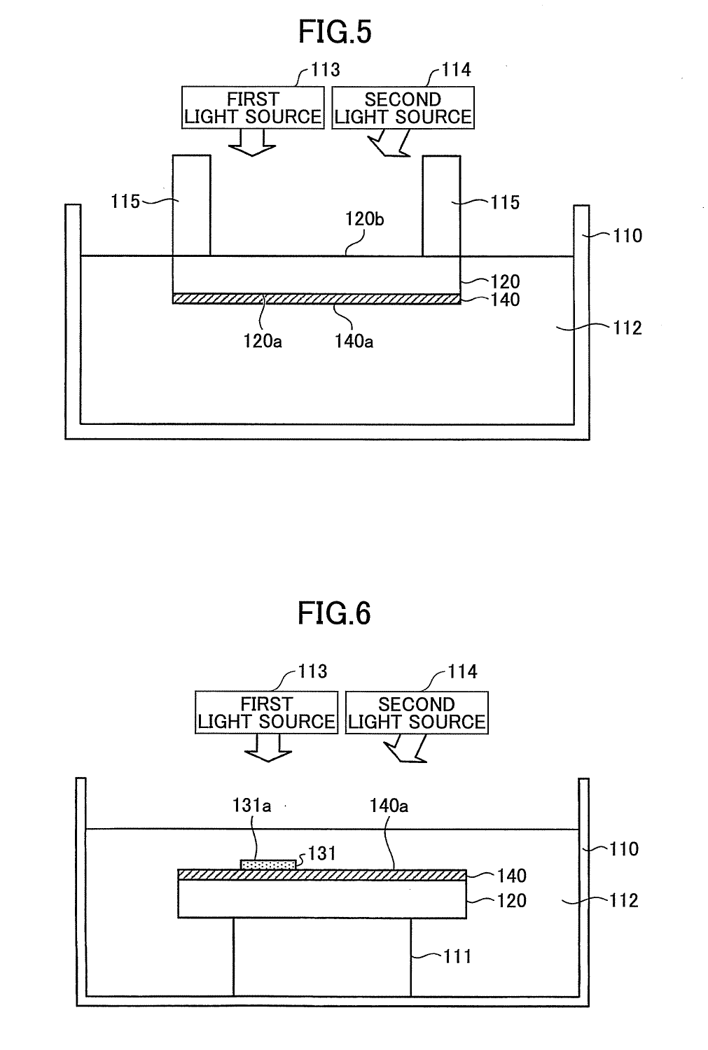

The method of irradiating from the side of the substrate 120 is not limited to the method illustrated with FIG. 4. As illustrated in FIG. 5, the substrate 120 may be positioned above the metal oxide precursor solution 112. It is to be noted that the substrate 120 may be positioned in a manner that the first main surface 140a of the electrode layer 140 faces a bottom surface of the reaction container 110 and positioned in a manner contacting the metal oxide precursor solution 112. In the example illustrated in FIG. 5, the second main surface 120b of the substrate 120 is positioned on or above the metal oxide precursor solution 112. Further, the substrate 120 is fixed to an upper area of the metal oxide precursor solution 112 by fixing members 115. Further, the first and second light sources 113 and 114 are positioned towards the side of the second main surface 120b. Accordingly, laser beams are irradiated from the side of the second main surface 120b.

As another example according to the first embodiment of the present invention, the first light source 113 may irradiate a laser beam from the side of the first main surface 140a of the electrode layer 40 and the second light source 114 may irradiate a laser beam from the side of the second main surface 120b of the substrate 120. As yet another example according to the first embodiment of the present invention, the second light source 114 may irradiate a laser beam from the side of the first main surface 140a of the electrode layer 140 and the first light source 113 may irradiate a laser beam from the side of the second main surface 120b of the substrate 120.

### Second Embodiment

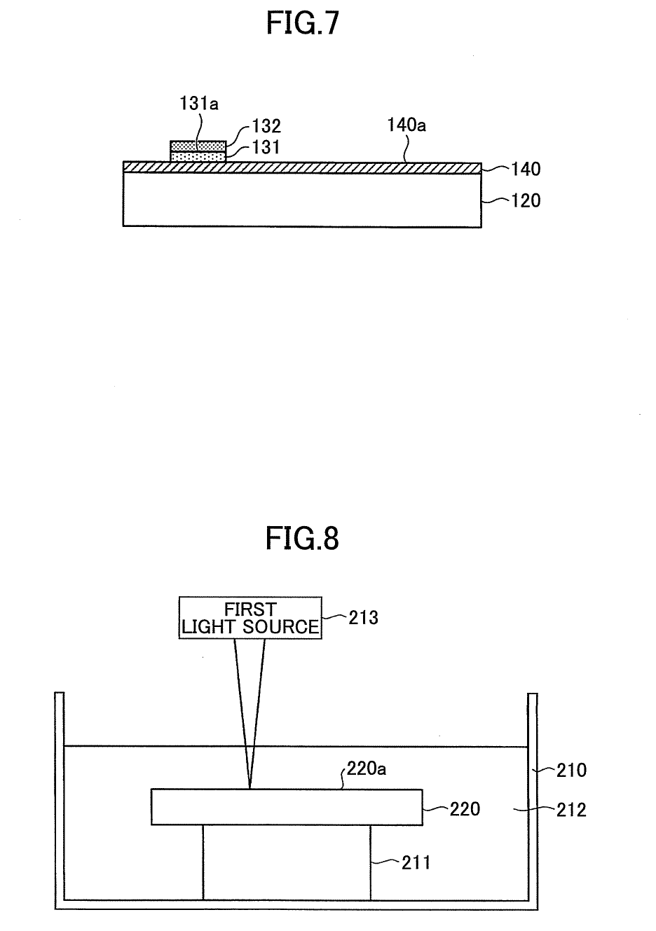

Next, a thin film manufacturing method according to a second embodiment of the present invention is described. FIGS. 6 and 7 are for describing the second embodiment where a multilayer film is formed for increasing film thickness. More specifically, after a first thin film 131 is formed on the electrode layer 140, a second thin film 132 is formed on the first thin film 132 by irradiating laser beams from the first and second light sources 113 and 114 as illustrated in FIGS. 6 and 7. In the second embodiment, each of the first and second thin films 131 and 132 is formed having a thickness equal to or less than 0.1 μm. It is preferable for the multilayer film (formed of the first and second thin films 113 and 114) to have a thickness of 0.5 μm to a few μm.

In a case of forming the second thin film 132, the conditions of the outputs of the first and second light sources 113, 114 are different from the conditions of the outputs of the first and second light sources 113 and 114 used in forming the first thin film 131. Compared to forming the first thin film 131, the output of the first light source 113 is reduced and the output of the second light source 114 is increased in the case of forming the second thin film 132. The focal depths of the first and second light sources 113 and 114 are changed for forming the second thin film 132 on the first main surface 131a of the first thin film 131.

The laser beam irradiated from the second light source 114 permeates (transmits) through the thin film pattern 130 and the electrode layer 140 and reaches the substrate 120. Thereby, the substrate 120 is heated. Accordingly, compared to forming the first thin film 131 on the electrode layer 140, greater thermal energy amounting to the thermal capacity of the first thin film 131 is required for heating the substrate 120. Therefore, the output of the second light source 114 is to be increased to an amount that is substantially equivalent to the thermal capacity of the first thin film 131.

On the other hand, because a layer(s) is to be formed on the first thin film 131, it is necessary to adjust the depth of the transmittance of light from the first light source 113 for changing a focal depth of the first light source 113 to a focal depth of the second light source 114. Accordingly, the output of the laser beam irradiated from the first light source 113 is reduced in correspondence with the difference between the first main surface 140a of the electrode layer 140 and the first main surface 131a of the thin film 131.

Accordingly, by repeating the adjusting operation of reducing the output of the first light source 113 and increasing the output of the second light source 114, a multilayer film having three or more layers can be formed.

Other than the above-described steps performed in the thin film manufacturing method according to the second embodiment, the steps of the thin film manufacturing method according to the second embodiment are substantially the same as those of the thin film manufacturing method according to the first embodiment.

### Third Embodiment

FIG. 8 is a schematic diagram illustrating a thin film manufacturing method according to a third embodiment of the present invention. In the third embodiment, an example of a method for forming a thin film used for a piezoelectric element is described. As illustrated in FIG. 8, a pedestal 211 is placed in a reaction container 210. A substrate 220 on which a thin film is to be formed is placed on the pedestal 211. The substrate 220 may be, for example, a silicon substrate. The reaction container 210 is filled with a metal oxide precursor solution 212. A first light source 213 is positioned above the substrate 220. The light source 213 irradiates a laser beam having a wavelength equal to or more than 400 nm.

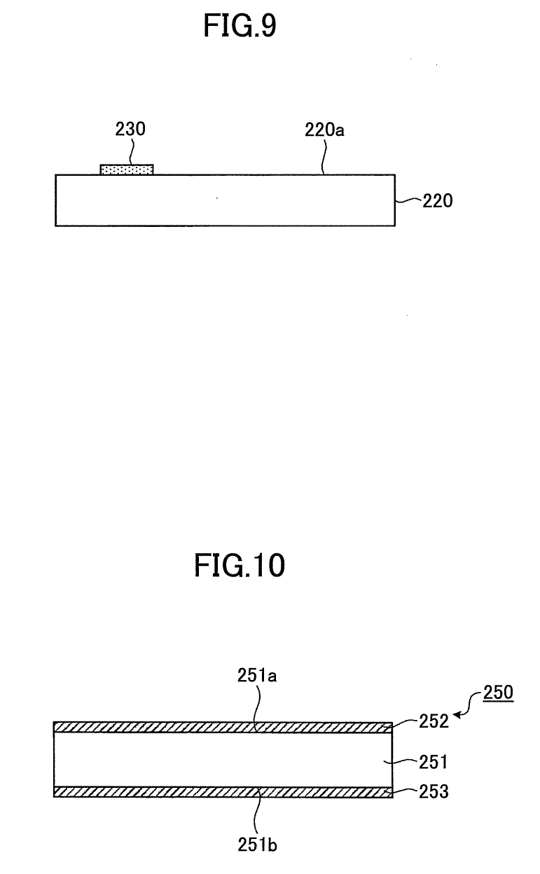

The first light source 213 irradiates a laser beam to the surface of the substrate 220, that is, a first main surface 220a of the substrate 220. It is to be noted that, among the first main surface 220a and the below-described second main surface 220b of the substrate 220, the first main surface 220a is the main surface situated closer to the first light source 213 than the second main surface 220b. Accordingly, by irradiating a laser beam to the first main surface 220a, a thin film pattern 230 of a metal oxide amorphous or a metal oxide crystal is obtained from the metal oxide precursor and is formed on the irradiated portion of the first main surface 220a as illustrated in FIG. 9.

The first light source 213 is capable of irradiating a laser beam to respective areas on the first main surface 220a. Therefore, the thin film pattern 230 can be formed on the first main surface 220a of the substrate 220 by irradiating a laser beam to a desired portion(s) on the first main surface 220a. It is to be noted that the light irradiated to the substrate 220 is not limited to a laser beam. Other types of light may be used for irradiation as long as the light has a wavelength suitable for forming a thin film in correspondence with the metal oxide precursor solution 212.

It is to be noted that other than the step process of dipping the substrate 220 in the metal oxide precursor solution 212, the processes performed for forming the thin film are substantially the same as those perform with a sol-gel method. The metal oxide precursor solution 212 is substantially the same as the metal oxide precursor solution applied onto the substrate.

After a thin film is formed inside the metal oxide precursor solution 212, the substrate 220 is cleaned when removing the substrate 220 from the metal oxide precursor solution 212. For example, ultrasonic cleaning by using a solvent or rinsing by using a solvent is performed on the substrate 220. It is preferable for the solvent to have a relatively high volatility and to have a small amount of moisture content. More specifically, the solvent may be, for example, acetone, ethanol, or IPA (Isopropyl alcohol). By using the solvent, metal alkoxide in the metal oxide precursor solution 212 can be prevented from remaining on the substrate 220 (prevention of residue on substrate 220).

After the cleaning, thermal processing is discretionally performed on the thin film formed on the substrate 220 according to the state of the thin film (mainly according to the crystallinity of the thin film). In a case where the thin film is crystalline, for the purpose of drying, the thin film is heated to the extent of not changing the shape of the crystals of the thin film. For example, the thin film is heated at a temperature of approximately 100-150° C. The heating may be discretionally performed in an appropriate atmosphere. For example, in a case where the thin film has a deliquescent property, the heating is performed in an inert gas atmosphere having little residual moisture. In a case where the thin film is non-crystalline, the thin film may not exhibit a desired function unless the material of the thin film (e.g., piezo material) is crystallized. Accordingly, in such case where the thin film is non-crystalline, the thin film is heated for the purpose of crystallizing the material of the thin film. The temperature and time for heating the thin film differs depending on the material of the thin film. For example, in a case where the material of the thin film is PZT (lead zirconate titanate), the thin film is heated at a temperature of approximately 600-800° C. for approximately 1-10 minutes.

More specifically, the metal oxide precursor may be made of a substance capable of forming a metal oxide thin film. In other words, a substance capable of forming a metal oxide amorphous or a metal oxide crystal may be used as the substance for forming the metal oxide precursor. For example, a metal complex (e.g., a metal alcoxide, a β-diketonato complex, or a metal chelate) or a metal carboxylate may be used as the substance for forming the metal oxide precursor. For example, an ethanol type organic solvent may be used as the solvent in forming the metal oxide precursor.

The metal alcoxide may be, for example, Si, Ge, Ga, As, Sb, Bi, V, Na, Ba, Sr, Ca, La, Ti, Ta, Zr, Cu, Fe, W, Co, Mg, Zn, Ni, Nb, Pb, Li, K, Sn, Al, or Sm. Further, a metal alcoxide including an alcoxyl group (e.g., OCH₃, OC₂H₅, OC₃H₇, OC₄H₉, OC₂H₄OCH₃) may also be used.

The β-diketonato complex may be, for example, metal and acetylacetone, a benzoyl acetone, a benzoyl-trifluoroacetone, a benzoyl-difluoroacetone, and a benzoyl-fluoroacetone.

The metal carboxylate may be, for example, a barium acetate, a copper acetate (II), a lithium acetate, a magnesium acetate, a zinc acetate, a barium oxalate, a calcium oxalate, a copper oxalate (II), a magnesium oxalate, or a tin oxalate (II). An alcohol type organic solvent may be used as the solvent in forming the metal oxide precursor. The density of the solvent is preferably 0.1-1 mol/l. More preferably, the density of the solvent is 0.3-0.7 mol/l. It is to be noted that the upper limit value of the density is determined from the aspect of attaining liquid stability. The lower limit value of the density is determined from the aspect of the speed of depositing the thin film.

In the third embodiment, because a laser beam is irradiated to the substrate 220 being in a state dipped inside the metal oxide precursor solution 212, a thin film is formed only at a portion of the substrate 220 on which the laser beam is irradiated. Accordingly, steps performed in a conventional sol-gel method such as a step of adding and drying a metal oxide precursor solution and a step of dry-etching or wet-etching for removing the metal oxide solution can be omitted. These steps of the conventional sol-gel method generate a significant amount of manufacturing cost. Therefore, because these steps can be omitted by using the thin film manufacturing method according to an embodiment of the present invention, manufacturing cost can be significantly reduced.

Further, because thin film formation reaction occurs inside the metal oxide precursor solution 212, the metal oxide precursor solution 212 is constantly being supplied during the thin film formation reaction. Therefore, cracks can be prevented from being created in the thin film.

The thin film formed by the thin film manufacturing method according to the third embodiment of the present invention may be used as, for example, an ultrasonic piezoelectric element, a non-volatile memory element (e.g., FET), or an actuator element. More specifically, the actuator element may be used for, for example, a recording head of an inkjet printer.

FIG. 10 illustrates a piezoelectric element 250 having an active layer (piezoelectric film 251) formed by the thin film manufacturing method according to the third embodiment of the present invention. The piezoelectric element 250 includes the piezoelectric film 251, a first electrode 252 formed a first main surface 251a of the piezoelectric film 251, and a second electrode 253 formed on a second main surface 251b of the piezoelectric film 251. The piezoelectric film 251 is formed by the thin film manufacturing method according to the third embodiment of the present invention. The first and second electrodes 251, 252 may be formed with a material having a conductive property such as platinum (Pt), a lanthanum-nickel-oxide or a strontium-ruthenium-oxide having high light transmittance. The first and second electrodes 251, 252 may be formed by using, for example, a sputtering method or a vacuum deposition method.

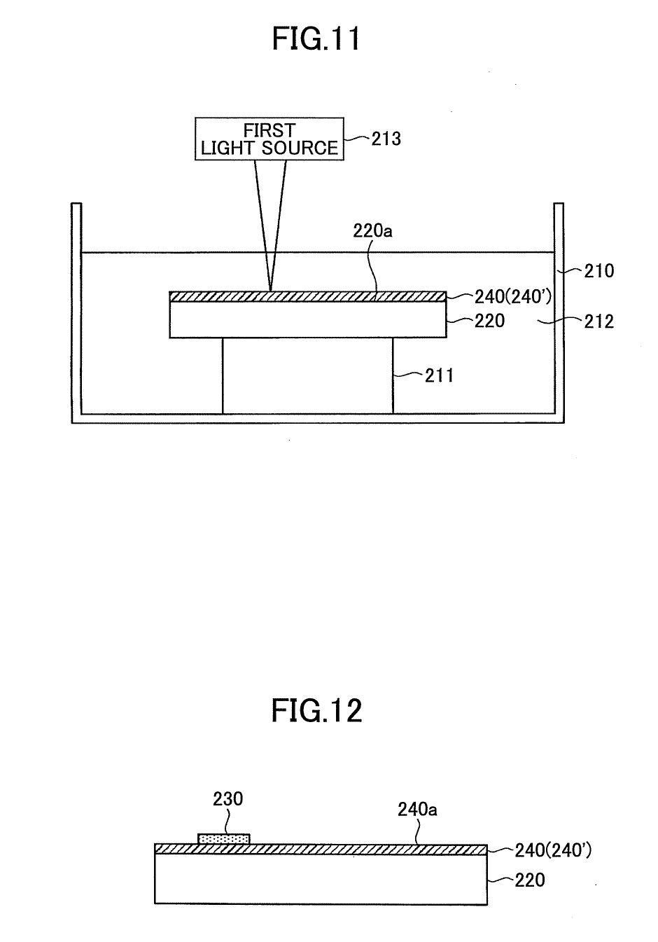

FIG. 11 illustrates a first modified example of the thin film manufacturing method according to the third embodiment of the present invention. In the first modified example of the third embodiment, a substrate 220, which already has the electrode layer 240 formed on a first main surface 20a, is used. A material having a conductive property can be used to form the electrode layer 240 by using, for example, a sputtering method. It is to be noted that the electrode layer 40 may be formed on the substrate 220 in a patterned state.

By dipping the substrate 220 including the conductive layer 240 into the metal oxide precursor solution 212, the thin film pattern 230 is formed on the first main surface 240a of the electrode layer 240 as illustrated in FIG. 12. Other than the above-described step performed in the thin film manufacturing method according to the first modified example of the third embodiment, the steps of the thin film manufacturing method according to the first modified example of the third embodiment are substantially the same as those of the thin film manufacturing method according to the third embodiment.

In a second modified example of the third embodiment, a substrate 220 having the electrode layer 240 is replaced by a light absorbing layer 240′. In the second modified example, the light absorbing layer 240′ formed on the first main surface 220a of the substrate 220 can absorb a laser beam having a predetermined wavelength irradiated from the first light source 213. The light absorbing layer 240′ may be formed on the substrate 220 in a patterned state. Although the light absorbing layer 240′ differs depending on the wavelength of the irradiated laser beam, a metal oxide material, a metal nitride material, or a metal carbide material such as SiO₂, SiN, TiO₂, SiC may be used as the material for forming the light absorbing layer 240′.

By dipping the substrate 220 including the light absorbing layer 240′ into the metal oxide precursor solution 212, a thin film pattern can be formed on the first main surface of the light absorbing layer 240′. Other than the above-described step performed in the thin film manufacturing method according to the second modified example of the third embodiment, the steps of the thin film manufacturing method according to the second modified example of the third embodiment are substantially the same as those of the thin film manufacturing method according to the third embodiment. Hence, by providing the light absorbing layer on the substrate 220, light absorptivity of the substrate 220 can be improved and a greater amount of optical energy can be absorbed.

In a third modified example of the third embodiment, the electrode layer 240 described in the first modified example of the third embodiment may also serve as a light absorbing layer. That is, the electrode layer 240 may also have a light absorbing property. For example, an oxide material capable of functioning as an electrode such as LaNiO₃, SrRuO₃, or ITO can be used as the layer serving as both the electrode layer and the light absorbing layer.

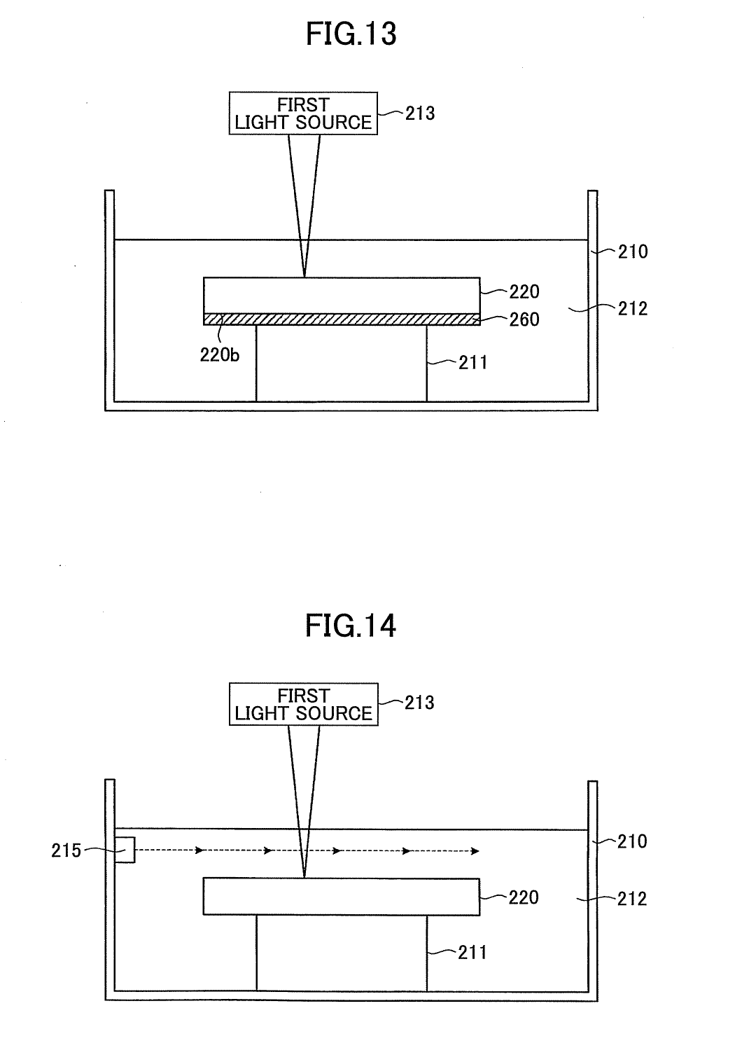

In a fourth modified example of the third embodiment, the substrate 220 may be dipped in the metal oxide precursor solution 212 in a state where a light reflecting layer 260 is formed on the second main surface 220b (back of the substrate 220, opposite side of the first main surface 220a) of the substrate 220 as illustrated in FIG. 13. Because an irradiated laser beam is reflected from the light reflecting layer 260 and re-enters (incident again) the substrate 20, the thin film formation reaction can be accelerated. Although the light reflecting layer differs depending on the wavelength of the irradiated laser beam, a metal material such as Au, Ag, Al, or Pt may be used as the material for forming the light reflecting layer 260.

In a fifth modified example of the third embodiment, a thin film other than the thin film used as a piezoelectric element may be formed with the thin film manufacturing method of the third embodiment. That is, the type of thin film formed by the thin film manufacturing method is not limited to the above-described thin film used as a piezoelectric element. In the thin film manufacturing method according to the third embodiment, the raw material of the solution used for forming the thin film is not limited in particular as long as the substrate is dipped in the solution of the raw material.

An example of the thin film formed by the thin film manufacturing method according to the third embodiment is a thin film having a translucent property and an electro-optical effect. For example, the thin film having a translucent property and an electro-optical effect may be used for an optical waveguide, an optical switch, a spatial light modulator, or an optical image memory.

### Fourth Embodiment

FIG. 14 is a schematic diagram illustrating a thin film manufacturing method according to a fourth embodiment of the present invention. In the fourth embodiment, as illustrated in FIG. 14, the metal oxide precursor solution 212 inside the reaction container 210 is caused to flow by a first stream motor 215 in performing a thin film forming process. More specifically, the first stream motor 215 is placed inside the reaction container 210 and is driven to cause the metal oxide precursor solution 212 to flow in a direction substantially parallel to the first main surface 220a of the substrate 220.

Thereby, decomposition products generated in the thin film forming process can be quickly removed. That is, decomposition products generated inside the reaction container 210 can be prevented from adversely affecting the thin film forming process.

It is to be noted that other than placing the first stream motor 215 in the reaction container 210 in the thin film manufacturing method according to the fourth embodiment, the processes performed for forming the thin film are substantially the same as those performed in the above-described thin film manufacturing method according to third embodiment.

In a first modified example of the fourth embodiment, the direction of the flow of the metal oxide precursor solution 212 may be different from that of the above-described fourth embodiment. For example, the metal oxide precursor solution 212 may be caused to flow in a circumferential direction in which the center of the circumferential flow is substantially the center of the substrate 220.

In a second modified example of the fourth embodiment, an ultrasonic generator may be used instead of the first stream motor 215 for causing the flow of the metal oxide precursor solution 212. By generating ultrasonic waves inside the metal oxide precursor solution 212 with the ultrasonic generator, the metal oxide precursor solution 212 can be caused to flow inside the reaction container 210.

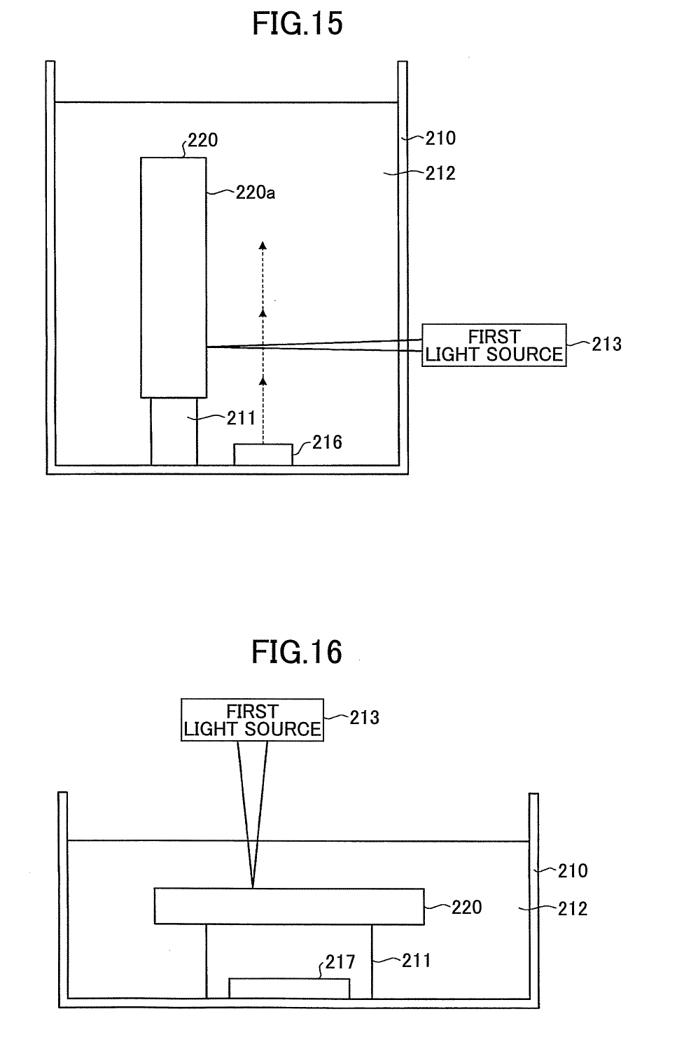

FIG. 15 is a schematic diagram for describing a third modified example of the fourth embodiment. In the third modified example of the fourth embodiment, the substrate 220 is placed on the pedestal 211 in a manner that the first main surface 220a is substantially parallel with respect to a vertical direction of the reaction container 210. Further, the reaction container 210 is formed with a material allowing a laser beam from the first light source 213 to permeate (transmit) through the sidewalls of the reaction container 210. In the third modified example, the light source 213 irradiates the laser beam in a horizontal direction of the reaction container 210. Thereby, a thin film is formed on the first main surface 220a of the substrate 220. It is to be noted that the first light source 213 is movable. Thus, the first light source 213 can irradiate a laser beam to a desired area(s) of the first main surface 220a of the substrate 220.

Further, in the third modified example of the fourth embodiment, a second stream motor 216 is placed inside the reaction container 210 as illustrated in FIG. 15. In the thin film forming process, the second stream motor 216 causes the metal oxide precursor solution 212 to flow in a direction opposite of gravity, that is, in a direction from the bottom of the reaction container 210 to the surface of the metal oxide precursor solution 212.

Thereby, decomposition products generated in the thin film forming process can be quickly removed. Further, because the generated decomposition products have lower specific gravity compared to the metal oxide precursor solution 212, the decomposition products migrate towards the surface of the metal oxide precursor solution 212. Accordingly, by causing the flow of the metal oxide precursor solution 212 with the second stream motor 216, the migration of the decomposition products can be accelerated.

FIG. 16 is a schematic diagram for describing a fourth modified example of the fourth embodiment. In the fourth modified example of the fourth embodiment, the pedestal 211 supporting the substrate 220 is rotated to cause the flow of the metal oxide precursor solution 212 instead of using the first stream motor 215 or the second stream motor 216. Thereby, the metal oxide precursor solution 212 is caused to flow relative to the substrate 220. In the fourth modified example of the fourth embodiment, a pedestal motor 217 is provided inside the pedestal 211 as illustrated in FIG. 16. The pedestal motor 217 rotates the pedestal 211 substantially concentrically around the center of the substrate 220. As long as the rotation of the pedestal 211 causes the flow of the metal oxide precursor solution 212, the pedestal 211 may be, for example, repetitively rotated back and forth between two points of a straight line. Alternatively, the pedestal 211 may be vibrated for causing the flow of the metal oxide precursor solution 212.

### Fifth Embodiment

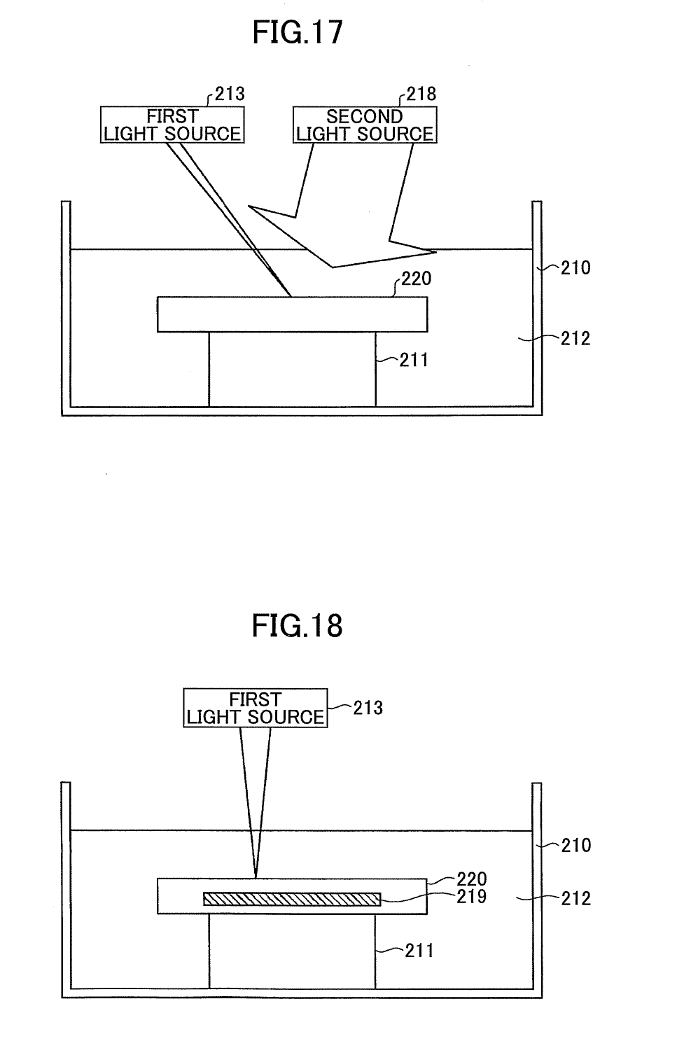

FIG. 17 is a schematic diagram for describing a thin film forming method according to a fifth embodiment of the present invention. In the fifth embodiment, as illustrated in FIG. 17, another excitation light is irradiated from a second light source 218 in addition to irradiating a laser beam from the first light source 213 in the thin film forming process. The light irradiated from the second light source 218 may be, for example, a UV (ultraviolet) light, a visible light, or an IR (infrared) light. In this example, the light irradiated from the second light source 218 has less energy compared to the light irradiated for initiating the reaction for forming the thin film. Further, the light of the second light source 218 is irradiated to the entire substrate 220. It is to be noted that the first light source 213 irradiates a spot laser beam to an area of the substrate 220 on which the thin film 230 is to be formed.

Further, a substantial amount of energy may be provided beforehand to the second light source 218 so that irradiation of a laser beam can be switched from irradiation from the first light source 213 to irradiation from the second light source 218. Thereby, the output (amount of energy) of the laser beam irradiated from the first light source 113 can be reduced. If a laser beam is irradiated from only a single light source, there may be a case where a high output (high energy) is required or a case where a necessary amount of energy cannot be obtained. However, with the fifth embodiment, energy required for causing reaction can be obtained from not only the first light source 213 but also another light source. Therefore, the first light source 213 is not required to be a high output light source. Thus, manufacturing cost of the apparatus including the first light source 213 can be reduced.

Other than irradiating a laser beam from the second light source 218 in the thin film forming process according to the fifth embodiment, the steps of the thin film manufacturing method according to the fifth embodiment are substantially the same as those of the thin film manufacturing method according to the third embodiment.

In a first modified example of the fifth embodiment, instead of irradiating a laser beam from the first light source 13 in the thin film forming process, thermal energy may be applied to the substrate 220. As illustrated in FIG. 18, a micro-heater 219 is embedded inside the substrate 220. Then, in the thin film forming process, the micro-heater 219 is switched on and heats the entire substrate 220. In the state where the substrate 220 is being heated by the micro-heater 219, a thin film is formed by irradiating a laser beam from the first light source 213.

With the first modified example of the fifth embodiment, because some amount of energy is applied to the substrate 220 by heating the substrate 220 with the micro-heater 219, the first light source 213 is not required to be a high output light source (reduction of output of laser beam of the first light source 213).

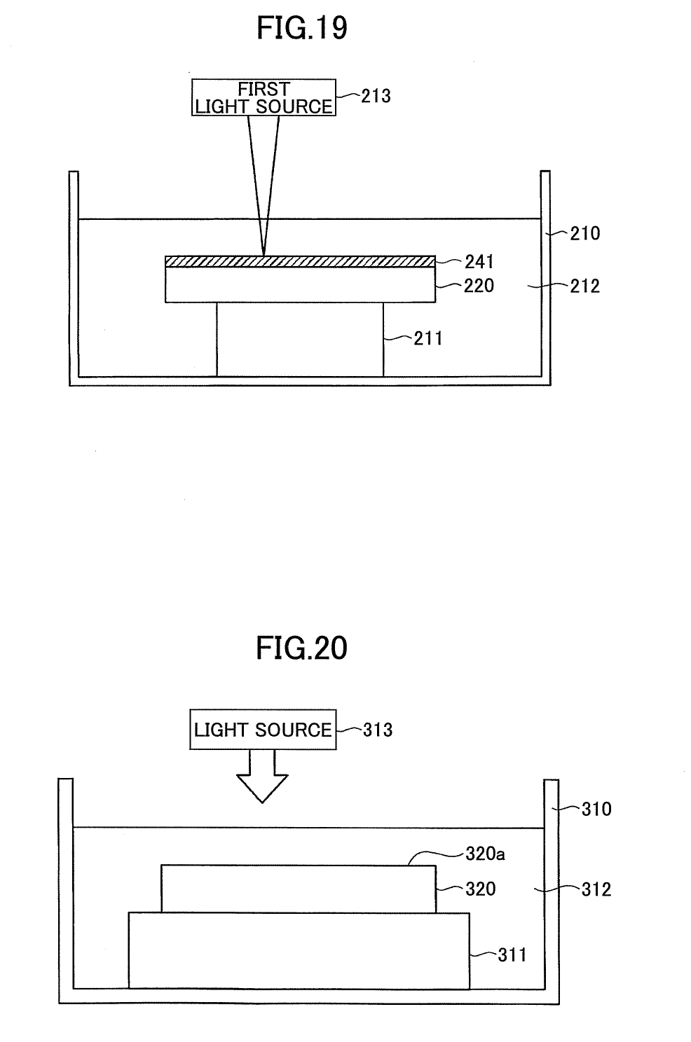

In a second modified example of the fifth embodiment, the electrode layer 241 also serving as a micro-heater may be formed on the substrate 220 as illustrated in FIG. 19. Similar to the first modified example of the fifth embodiment, in the thin film forming process, a micro-heater portion of the electrode layer 241 is switched on and heats the entire substrate 220. In the state where the substrate 220 is being heated by the micro-heater portion of the electrode layer 241, a thin film is formed by irradiating a laser beam from the first light source 213. With the second modified example of the fifth embodiment, because the substrate 220 is heated by heating the electrode layer 241 with the micro-heater portion, the first light source 213 is not required to be a high output light source (reduction of output of laser beam of the first light source 213).

### Sixth Embodiment

FIG. 20 is a schematic diagram illustrating a thin film manufacturing method according to a sixth embodiment of the present invention. In the sixth embodiment, an example of a method for forming a thin film used for a piezoelectric element is described. As illustrated in FIG. 20, a pedestal 311 is placed in a reaction container 310. A substrate 320 on which a thin film is to be formed is placed on the pedestal 311. The reaction container 310 is filled with a metal oxide precursor solution 312. A first light source 313 is positioned above the substrate 320. That is, the first light source 313 is positioned to face towards the first main surface 320a of the substrate 320. The light source 313 irradiates a laser beam from above the metal oxide precursor solution.

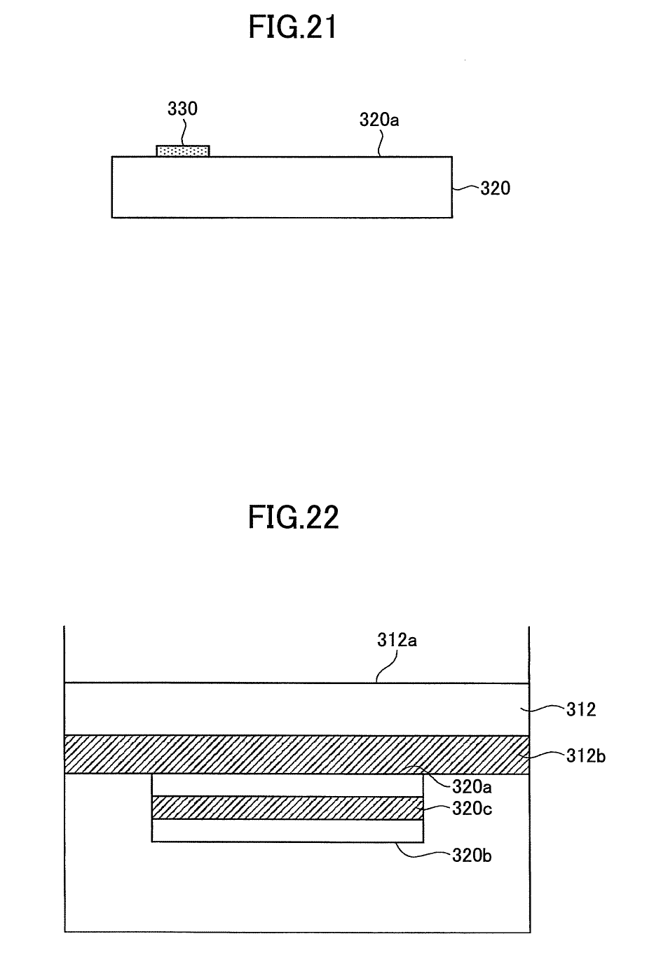

By irradiating the laser beam to an area(s) of the first main surface 220a, a thin film pattern (also simply referred to as “thin film”) 330 of an amorphous metal oxide or a crystalline metal oxide is obtained from the metal oxide precursor 312 and is formed on the irradiated area of the first main surface 320a as illustrated in FIG. 21. The light source 313 can irradiate the laser beam to each area on the first main surface 320a of the substrate 320. Accordingly, the thin film pattern 330 can be formed on a desired area on the first main surface 320a of the substrate 320. It is to be noted that the light irradiated to the substrate 320 is not limited to a laser beam. Other types of light may be selected as long as the light has a wavelength appropriate for forming a thin film in accordance with the metal oxide precursor solution 312.

In the sixth embodiment, there are five target irradiation areas where a target to be irradiated (irradiation target) may be located see FIG. 22). The five positions are the surface 312a of the metal oxide precursor solution 312, an inside area 312b of the metal oxide precursor solution 312, the first main surface 320a of the substrate 320, an inner portion 320c of the substrate 320, and/or a second main surface 320b at the back of the substrate 320.

The irradiation of the laser beam to each of the target irradiation areas is performed by adjusting the focal point of the laser beam. In a case of irradiating the laser beam to the metal oxide precursor solution 312, the substrate 320 is to be arranged in a manner where the first main surface 320a is positioned in a relatively shallow area inside the metal oxide precursor solution 312 to the extent that the irradiated area does not deviate from an area of the first main surface on which the thin film 330 is to be formed. The target irradiation areas and the effects of irradiation at the target irradiation areas are illustrated in the following Table 3.

TABLE 3

| | | | | | a. | | c. | d. | | f. |
|---|---|---|---|---|---|---|---|---|---|---|
| | | | | | THIN | | HIGH | HIGH | e. | SIM- |
| | | | | | FILM | | ADHESIVE- | ACCU- | SELEC- | PLIC- |
| | | | | TYPE | FORM- | b. | NESS | RACY/ | TION | ITY |
| | | | | OF | ING | SUB- | BETWEEN | HIGH | OF | OF |
| | | | | SOLU- | WITH | STRATE | SUB- | RESOLU- | SUB- | OPTI- |
| | | BEHAVIOUR OF | | TION | FEW | WITH | STRATE | TION | STRATE | CAL |
| | HEATING | OPTICAL ENERGY | | REAC- | IMPUR- | LITTLE | AND | PATTERN- | MATE- | APPA- |
| CASE | AREA | SOLUTION | SUBSTRATE | TION | ITIES | DAMAGE | FILM | ING | RIAL | RATUS |
| A | SOLUTION | ABSORB | — | DIRECT | ∘ | ∘ | x | ∘ | ∘ | x |
| | SURFACE | | | HEATING | | | | | | |
| B | INSIDE OF | ABSORB | — | DIRECT | ∘ | ∘ | x | ∘ | ∘ | x |
| | SOLUTION | | | HEATING | | | | | | |
| C | SOLUTION/ | | | INDIRECT | x | x | ∘ | x | ∘ | ∘ |
| | SUBSTRATE | PERMEATE | ABSORB | HEATING | | | | | | |
| | INTERFACE | | | | | | | | | |
| D | INNER | PERMEATE | ABSORB | INDIRECT | x | x | ∘ | x | ∘ | ∘ |
| | PORTION | | | HEATING | | | | | | |
| | OF | | | | | | | | | |
| | SUBSTRATE | | | | | | | | | |
| E | BACK | PERMEATE | ABSORB | INDIRECT | x | x | ∘ | x | ∘ | ∘ |
| | OF | | | HEATING | | | | | | |
| | SUBSTRATE | | | | | | | | | |
| | SURFACE | | | | | | | | | |

In case A, the surface of the metal oxide precursor solution 312 is the target irradiation area (i.e. heating area). In this case, approximately few tens of percent of optical energy are absorbed by the metal oxide precursor solution 312 and the remaining optical energy reaches the substrate 320. The optical energy reaching the substrate 320 is either absorbed by the substrate 320 or permeates (transmits) through the substrate 320. The type of solution reaction performed in the case A is direct heating in which the metal oxide precursor solution 312 is directly heated. In case B, an inside area of the metal oxide precursor solution 312 is the heating area. In the case B, optical energy is absorbed by the metal oxide precursor solution 112.

In case C, the interface between the metal oxide precursor solution 312 and the substrate 320, (i.e. first main surface 320a of the substrate 320) is the heating area. In case D, the inner portion 320c of the substrate 320 is the heating area. In case E, the second main surface 320b of the substrate 320 is the heating area. In the cases C, D, and E, most of the optical energy permeates (transmits) through the metal oxide precursor solution 312 and a small percent of the optical energy is absorbed by the substrate 320. The type of solution reaction performed in the cases C, D, and E are indirect heating in which the metal oxide precursor solution 312 is indirectly heated by heating the substrate 320. In a case of performing direct heating, the wavelength of the irradiated laser beam is equal to or less than 400 nm. In a case of performing indirect heating, the wavelength of the irradiated laser beam is equal to or more than 400 nm.

In a case of forming a thin film with few impurities (column a in Table 1), satisfactory results can be attained in the cases A and B where direct heating is performed. In the cases A and B, the optical energy can directly cut off (disconnect) the bond between carbon and oxygen inside the metal oxide precursor solution 312. As a result, generation of residual carbon and soot can be prevented. Thereby, a high quality thin film without impurities can be manufactured. On the other hand, in the cases C, D, and E, incomplete thermal decomposition of the metal oxide precursor solution 312 tends to occur due to indirect heating. This results in the generation of residual carbon and soot.

In a case of forming a thin film with little damage (column b in Table 1), satisfactory results can be attained in the cases A and B. In the cases A and B, the damage to the substrate 320 can be controlled to a small amount because optical energy hardly reaches the substrate 320. On the other hand, in the cases C, D, and E, the substrate 320 may be thermally damaged because the substrate 320 is heated.

In a case of forming a thin film with high adhesiveness between the substrate 320 and the thin film 330 (column c in Table 1), satisfactory results can be attained in the cases C, D, and E. In the cases C, D, and E, the adhesiveness between the substrate 320 and the thin film 330 may be increased owing to the phase change of the metal oxide precursor solution 312 occurring in the vicinity of the first main surface 320a of the substrate 320. On the other hand, in the cases A and B, the adhesiveness between the substrate 320 and the thin film 330 becomes relatively lower due to phase change occurring at the surface 312a of the metal oxide precursor solution 312 or occurring in the inside area 312b of metal oxide precursor solution 312.

In a case of forming a thin film with high accuracy and high resolution patterning (column d in Table 3), satisfactory results can be attained in the cases A and B. In the cases A and B, patterning can be performed with high accuracy and high resolution corresponding to the spot diameter of the laser beam. On the other hand, in the cases C, D, and E, the heating area tends to broaden compared to the spot diameter of the laser beam due to the thermal characteristics of the substrate 320. Therefore, the cases C, D, and E are inferior compared to the cases A and B from the aspect of high accuracy and high resolution patterning.

From the aspect of selection of the material of the substrate 320 (column e in Table 3), all of the cases A-E are satisfactory. For example, silicon may be used as the material of the substrate 320. From the aspect of light source, that is, the simplicity of the optical apparatus including the light source (column f in Table 3), the light used in the cases A and B has a short wavelength (e.g., equal to or less than 400 nm). Thus, the cases A and B require an expensive and sophisticated (difficult operability) optical apparatus such as a UV laser apparatus. On the other hand, the light used in the cases C, D, and E has a long wavelength (e.g., equal to or more than 400 nm). Thus, a CO₂ laser apparatus, which is relatively inexpensive and is generally suitable for performing processing, can be used in the cases C, D, and E.

It is to be noted that other than the step process of dipping the substrate 320 in the metal oxide precursor solution 312, the processes performed for forming the thin film 330 are substantially the same as those perform with a sol-gel method. The metal oxide precursor solution 312 is substantially the same as the metal oxide precursor solution applied onto the substrate.

After a thin film 330 is formed inside the metal oxide precursor solution 312, the substrate 320 is cleaned when removing the substrate 320 from the metal oxide precursor solution 312. For example, ultrasonic cleaning by using a solvent or rinsing by using a solvent is performed on the substrate 320. It is preferable for the solvent to have a relatively high volatility and to have a small amount of moisture content. More specifically, the solvent may be, for example, acetone, ethanol, or IPA (Isopropyl alcohol). By using the solvent, metal alkoxide in the metal oxide precursor solution 312 can be prevented from remaining on the substrate 320 (prevention of residue on substrate 320).

After the cleaning, thermal processing is discretionally performed on the thin film 330 formed on the substrate 320 according to the state of the thin film 330 (mainly according to the crystallinity of the thin film 330). In a case where the thin film 330 is crystalline, for the purpose of drying, the thin film 330 is heated to the extent of not changing the shape of the crystals of the thin film 330. For example, the thin film 330 is heated at a temperature of approximately 100-150° C. The heating may be discretionally performed in an appropriate atmosphere. For example, in a case where the thin film 330 has a deliquescent property, the heating is performed in an inert gas atmosphere having little residual moisture. In a case where the thin film 330 is non-crystalline, the thin film 330 may not exhibit a desired function unless the material of the thin film 330 (e.g., piezo material) is crystallized. Accordingly, in such case where the thin film 330 is non-crystalline, the thin film 330 is heated for the purpose of crystallizing the material of the thin film 330. The temperature and time for heating the thin film 330 differs depending on the material of the thin film 330. For example, in a case where the material of the thin film 330 is PZT (lead zirconate titanate), the thin film 330 is heated at a temperature of approximately 600-800° C. for approximately 1-10 minutes.

More specifically, the metal oxide precursor may be made of a substance capable of forming a metal oxide thin film. In other words, a substance capable of forming an amorphous metal oxide a crystalline metal oxide may be used as the substance for forming the metal oxide precursor. For example, a metal complex (e.g., a metal alcoxide, a β-diketonato complex, or a metal chelate) or a metal carboxylate may be used as the substance for forming the metal oxide precursor. For example, an ethanol type organic solvent may be used as the solvent in forming the metal oxide precursor.

The metal alcoxide may be, for example, Si, Ge, Ga, As, Sb, Bi, V, Na, Ba, Sr, Ca, La, Ti, Ta, Zr, Cu, Fe, W, Co, Mg, Zn, Ni, Nb, Pb, Li, K, Sn, Al, or Sm. Further, a metal alcoxide including an alcoxyl group (e.g., OCH₃, OC₂H₅, OC₃H₇, OC₄H₉, OC₂H₄OCH₃) may also be used.

The β-diketonato complex may be, for example, metal and acetylacetone, a benzoyl acetone, a benzoyl-trifluoroacetone, a benzoyl-difluoroacetone, and a benzoyl-fluoroacetone.

The metal carboxylate may be, for example, a barium acetate, a copper acetate (II), a lithium acetate, a magnesium acetate, a zinc acetate, a barium oxalate, a calcium oxalate, a copper oxalate (II), a magnesium oxalate, or a tin oxalate (II). An alcohol type organic solvent may be used as the solvent in forming the metal oxide precursor. The density of the solvent is preferably 0.1-1 mol/l. More preferably, the density of the solvent is 0.3-0.7 mol/l. It is to be noted that the upper limit value of the density is determined from the aspect of attaining liquid stability. The lower limit value of the density is determined from the aspect of the speed of depositing the thin film 330.

In the sixth embodiment, because a laser beam is irradiated to the substrate 320 being in a state dipped inside the metal oxide precursor solution 312, a thin film 330 is formed only at a portion of the substrate 320 on which the laser beam is irradiated. Accordingly, steps performed in a conventional sol-gel method such as a step of adding and drying a metal oxide precursor solution and a step of dry-etching or wet-etching for removing the metal oxide solution can be omitted. These steps of the conventional sol-gel method generate a significant amount of manufacturing cost. Therefore, because these steps can be omitted by using the thin film manufacturing method according to the sixth embodiment of the present invention, manufacturing cost can be significantly reduced.

Further, because thin film formation reaction occurs inside the metal oxide precursor solution 312, the metal oxide precursor solution 312 is constantly being supplied during the thin film formation reaction. Therefore, cracks can be prevented from being created in the thin film.

The thin film 330 formed by the thin film manufacturing method according to the sixth embodiment of the present invention may be used as, for example, an ultrasonic piezoelectric element, a non-volatile memory element (e.g., FET), or an actuator element. More specifically, the actuator element may be used for, for example, a recording head of an inkjet printer.

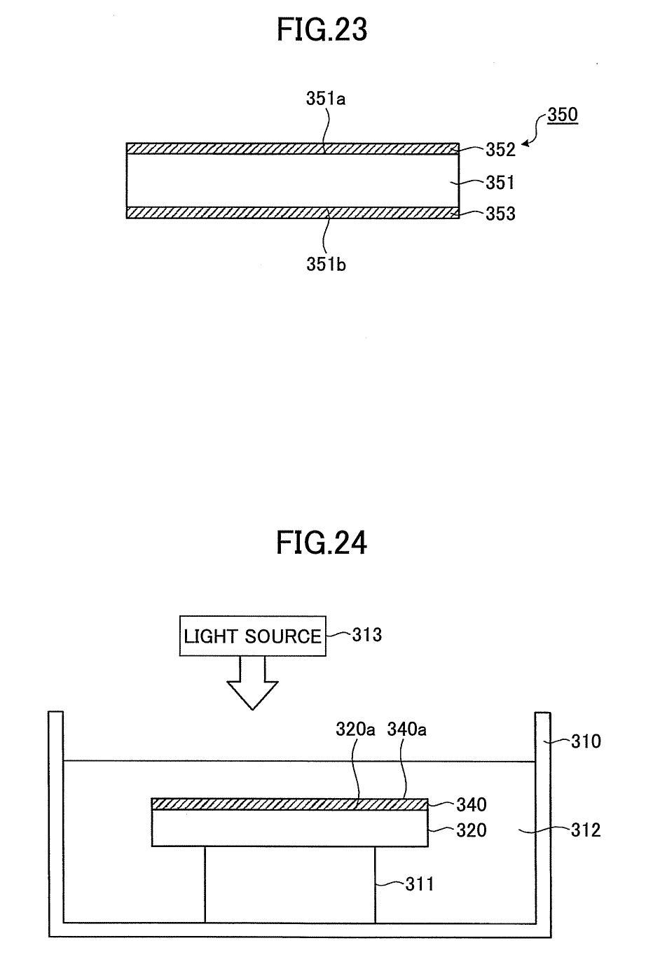

FIG. 23 illustrates a piezoelectric element 350 having an active layer (piezoelectric film 351) formed by the thin film manufacturing method according to the sixth embodiment of the present invention. The piezoelectric element 350 includes the piezoelectric film 351, a first electrode 352 formed a first main surface 351a of the piezoelectric film 351, and a second electrode 353 formed on a second main surface 351b of the piezoelectric film 351. The piezoelectric film 351 is formed by the thin film manufacturing method according to the sixth embodiment of the present invention. The first and second electrodes 351, 352 may be formed with a material having a conductive property such as platinum (Pt), a lanthanum-nickel-oxide or a strontium-ruthenium-oxide having high light transmittance. The first and second electrodes 351, 352 may be formed by using, for example, a sputtering method or a vacuum deposition method.

FIG. 24 illustrates a first modified example of the thin film manufacturing method according to the sixth embodiment of the present invention. In the first modified example of the sixth embodiment, a substrate 320, which already has the electrode layer 340 formed on a first main surface 320a, is used. A material having a conductive property can be used to form the electrode layer 340 by using, for example, a sputtering method. It is to be noted that the electrode layer 340 may be formed on the substrate 320 in a patterned state.

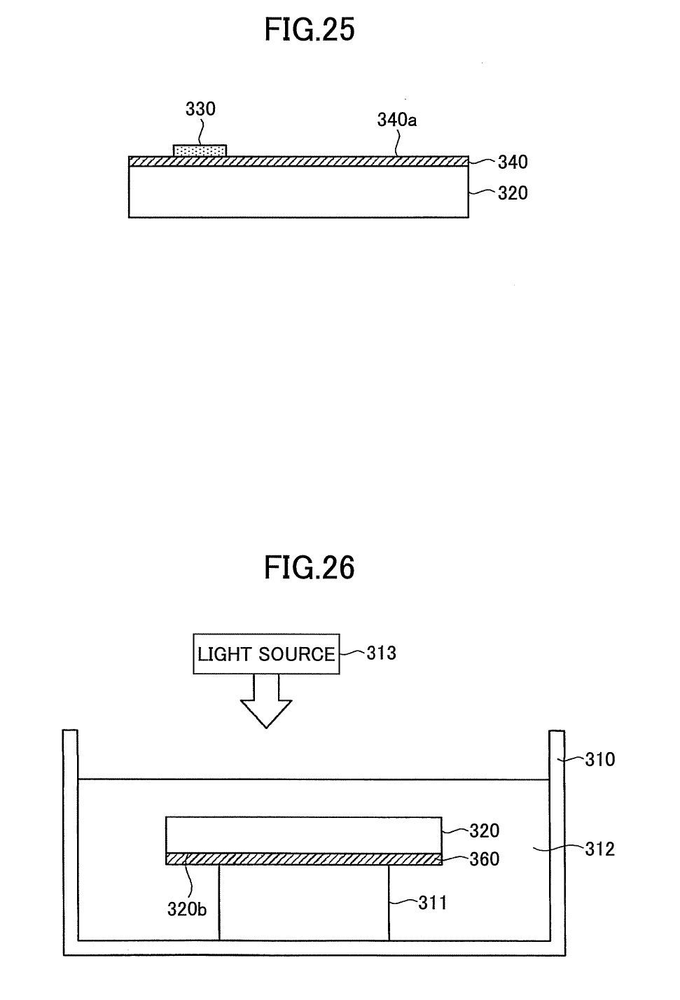

By dipping the substrate 320 including the conductive layer 340 into the metal oxide precursor solution 312, the thin film pattern 330 is formed on the first main surface 340a of the electrode layer 340 as illustrated in FIG. 25. Other than the above-described step performed in the thin film manufacturing method according to the first modified example of the sixth embodiment, the steps of the thin film manufacturing method according to the first modified example of the sixth embodiment are substantially the same as those of the thin film manufacturing method according to the sixth embodiment.

In a second modified example of the sixth embodiment, a substrate 320 has the electrode layer 340 replaced by a light absorbing layer. In the second modified example, the light absorbing layer formed on the first main surface 320a of the substrate 320 can absorb a laser beam having a predetermined wavelength irradiated from the first light source 313. The light absorbing layer may be formed on the substrate 320 in a patterned state. Although the light absorbing layer differs depending on the wavelength of the irradiated laser beam, a metal oxide material, metal nitride material, or a metal carbide material such as SiO₂, SiN, TiO₂, SiC may be used as the material for forming the light absorbing layer.

By dipping the substrate 320 including the light absorbing layer into the metal oxide precursor solution 312, thin film patterns can be formed on the first main surface of the light absorbing layer. Other than the above-described step performed in the thin film manufacturing method according to the second modified example of the sixth embodiment, the steps of the thin film manufacturing method according to the second modified example of the sixth embodiment are substantially the same as those of the thin film manufacturing method according to the sixth embodiment. Hence, by providing the light absorbing layer on the substrate 320, light absorptivity of the substrate 320 can be improved and a greater amount of optical energy can be absorbed.

In a third modified example of the sixth embodiment, the electrode layer 340 described in the first modified example of the sixth embodiment may also serve as a light absorbing layer. For example, an oxide material capable of functioning as an electrode such as LaNiO₃, SrRuO₃, ITO can be used as the layer serving as both the electrode layer and the light absorbing layer. Further, for example, in a case of forming a conductive film by performing the CSD method with a lanthanum-nickel-oxide, the conductive film can include a light absorbing layer by blending a light absorptivity enhancing material (e.g., dye) into the metal oxide precursor solution 312.

In a fourth modified example of the sixth embodiment, the substrate 320 may be dipped in the metal oxide precursor solution 312 in a state where a light reflecting layer 360 is formed on the second main surface 320b (back of the substrate 320, opposite side of the first main surface 320a) of the substrate 320 as illustrated in FIG. 26. Because an irradiated laser beam is reflected from the light reflecting layer 360 and re-enters (incident again) the substrate 320, the thin film formation reaction can be accelerated. Although the light reflecting layer differs depending on the wavelength of the irradiated laser beam, a metal material such as Au, Ag, Al, or Pt may be used as the material for forming the light reflecting layer 360.

In a fifth modified example of the sixth embodiment, a thin film 330 other than the thin film 330 used as a piezoelectric element may be formed with the thin film manufacturing method of the sixth embodiment. That is, the type of thin film formed by the thin film manufacturing method is not limited to the above-described thin film used as a piezoelectric element. In the thin film manufacturing method according to the sixth embodiment, the raw material of the solution used for forming the thin film is not limited in particular as long as the substrate is dipped in the solution of the raw material.

An example of the thin film formed by the thin film manufacturing method according to the sixth embodiment is a thin film having a translucent property and an electro-optical effect. For example, the thin film having a translucent property and an electro-optical effect may be used for an optical waveguide, an optical switch, a spatial light modulator, or an optical image memory.

### Seventh Embodiment

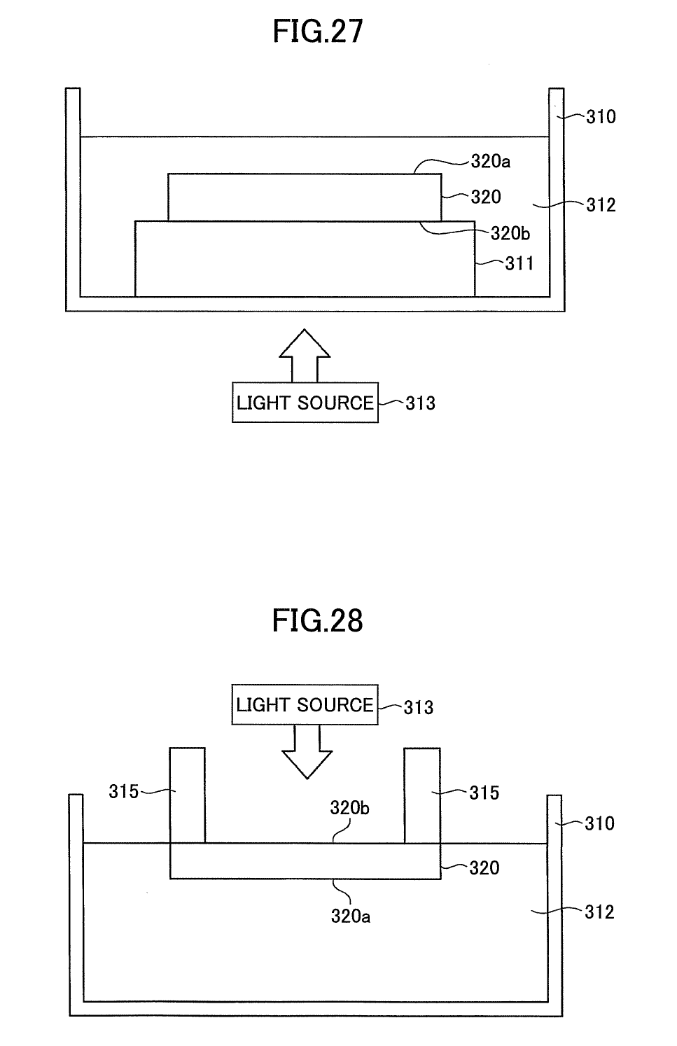

FIG. 27 is a schematic diagram illustrating a thin film manufacturing method according to a seventh embodiment of the present invention. In the seventh embodiment, the light source 313 is positioned facing towards the side of the second main surface 320b of the substrate 320 (opposite side of the first main surface 320a of the substrate 320). Accordingly, because the light source 313 is positioned towards the side of the second main surface 320b as illustrated in FIG. 27, a laser beam is irradiated from the side of the second main surface 320b. In a similar manner as the sixth embodiment of the present invention, a thin film is formed on the first main surface 320a by heating the metal oxide precursor solution 312 or the substrate 320. It is to be noted that the substrate 320, the pedestal 311, and the reaction container 310 of the seventh embodiment are formed of a material that allows the light from the light source 313 to permeate (transmits) therethrough.

As described in the sixth embodiment with reference to FIG. 22, there are five target irradiation areas where a target to be irradiated by the light source 313 can be located. The target irradiation areas and the effects of irradiation at the target irradiation areas are illustrated in the following Table 4.

TABLE 4

| | | | | | a. | | c. | d. | | f. |
|---|---|---|---|---|---|---|---|---|---|---|
| | | | | | THIN | | HIGH | HIGH | e. | SIM- |
| | | | | | FILM | | ADHESIVE- | ACCU- | SELEC | PLIC- |
| | | | | TYPE | FORM- | b. | NESS | RACY/ | TION | ITY |
| | | | | OF | ING | SUB- | BETWEEN | HIGH | OF | OF |
| | | | | SOLU- | WITH | STRATE | SUB- | RESOLU- | SUB- | OPTI- |
| | | BEHAVIOUR OF | | TION | FEW | WITH | STRATE | TION | STRATE | CAL |
| | HEATING | OPTICAL ENERGY | | REAC- | IMPUR- | LITTLE | AND | PATTERN- | MATE | APPA- |
| CASE | AREA | SOLUTION | SUBSTRATE | TION | ITIES | DAMAGE | FILM | ING | RIAL | RATUS |
| F | SOLUTION | ABSORB | PERMEATE | DIRECT | ∘ | Δ | x | ∘ | x | x |
| | SURFACE | | | HEATING | | | | | | |
| G | INSIDE OF | ABSORB | PERMEATE | DIRECT | ∘ | Δ | x | ∘ | x | x |
| | SOLUTION | | | HEATING | | | | | | |
| H | SOLUTION/ | ABSORB | PERMEATE | DIRECT | ∘ | Δ | ∘ | ∘ | x | x |
| | SUBSTRATE | | | HEATING | | | | | | |
| | INTERFACE | | | | | | | | | |
| I | INNER | — | ABSORB | INDIRECT | x | x | ∘ | x | ∘ | ∘ |
| | PORTION | | | HEATING | | | | | | |
| | OF | | | | | | | | | |
| | SUBSTRATE | | | | | | | | | |
| J | BACK | — | ABSORB | INDIRECT | x | x | ∘ | x | ∘ | ∘ |
| | OF | | | HEATING | | | | | | |
| | SUBSTRATE | | | | | | | | | |
| | SURFACE | | | | | | | | | |

In cases F, G, and H, optical energy permeates (transmits) through the substrate 320 and is absorbed by the metal oxide precursor solution 312. The type of solution reaction performed in the cases F, G, and H is direct heating. In cases I and J, optical energy is absorbed by the substrate 320. The type of solution reaction performed in the cases and J is indirect heating. Similar to the sixth embodiment, the irradiated light has a wavelength equal to or less than 400 nm in a case of direct heating, and the irradiated light has a wavelength equal to or more than 400 nm in a case of indirect heating.

In a case of forming a thin film with few impurities (column a in Table 4), satisfactory results can be attained in the cases F, G, and H where direct heating is performed. However, impurities may be generated in the case H because a part of the laser beam is absorbed by the metal oxide precursor solution 312 before the laser beam reaches the first main surface 320a of the substrate 320. Therefore, from the aspect of forming a thin film with few impurities, the case H is inferior compared to the cases F and G.

In a case of forming a thin film with little damage (column b in Table 4), the substrate 320 may be damaged in the cases F, G, and H due to a portion of the optical energy being converted into thermal energy when the laser beam permeates (transmits) through the substrate 320. Therefore, with respect to the aspect of forming a thin film with little damage, the cases F, G, and H may be inferior compared to the above-described cases A and B of the sixth embodiment. However, the cases F, G, and H are superior compared to the cases I and J.

In a case of forming a thin film with high adhesiveness between the substrate 320 and the thin film 330 (column c in Table 4), satisfactory results can be attained in the cases H, I, and J. In the cases H, I, and J, the adhesiveness between the substrate 320 and the thin film 330 may be increased owing to the phase change of the metal oxide precursor solution 312 occurring in the vicinity of the interface between the substrate 320 and the thin film 330. In a case of forming a thin film with high accuracy and high resolution patterning (column d in Table 4), satisfactory results can be attained in the cases F, G, and H. From the aspect of selection of the material of the substrate 320 (column e in Table 4), satisfactory results can be attained in the cases I and J where the substrate 320 is heated. On the other hand, the results are unsatisfactory in the cases F, G, and H. That is, only a few kinds of materials can be selected as the material of the substrate 320 because optical energy is required to permeate (transmit) through the substrate 320 in the cases F, G, and H.

From the aspect of an optical apparatus including a light source (column f in Table 4), an expensive and sophisticated optical apparatus that irradiates a laser beam of a short wavelength is required in the cases F, G, and H. On the other hand, a relatively inexpensive optical apparatus, which irradiates a laser beam of a long wavelength and is generally suitable for performing processing, can be used in the cases I and J.

Other than the above-described steps performed in the thin film manufacturing method according to the seventh embodiment, the steps of the thin film manufacturing method according to the seventh embodiment are substantially the same as those of the thin film manufacturing method according to the sixth embodiment. Further, similar to the sixth embodiment, an electrode layer or a light absorbing layer may be formed on the surface of the substrate 320.

FIG. 28 is a schematic diagram for describing a first modified example of the thin film manufacturing method according to the seventh embodiment of the present invention. In the first modified example of the seventh embodiment, the substrate 320 may be positioned above the metal oxide precursor solution 312. It is to be noted that the substrate 320 may be positioned in a manner that the first main surface 320a of the substrate 320 faces a bottom surface of the reaction container 310 and positioned in a manner contacting the metal oxide precursor solution 312. In the example illustrated in FIG. 28, the second main surface 320b of the substrate 320 is positioned on or above the metal oxide precursor solution 312. The substrate 320 is formed of a material allowing light from the light source 313 to permeate (transmit) therethrough. Further, the substrate 320 is fixed to an upper area of the metal oxide precursor solution 312 by fixing members 315. Further, the light source 313 is positioned to face towards the side of the second main surface 320b. Accordingly, a laser beam is irradiated from the side of the second main surface 320b. Thereby, the laser beam can be irradiated from the side of the second main surface 320b to the five target irradiation areas illustrated in FIG. 22.

In the tables above-described sixth and seventh embodiments in which the cases A-J are described with different irradiation directions and irradiation areas, the “circle” mark may indicate a rating of 1 point, the “triangle” mark may indicate a rating of 0.5 points, and the “X” mark may indicate a rating of 0 points. Accordingly, based on the total points of the ratings corresponding to each of the items a-f, each of the cases A-J can be evaluated. Further, the cases A-J may be evaluated by applying a greater weight (higher rating) to one or more of items a-f having more significance than the other items and calculating the total of each case.

### Eighth Embodiment

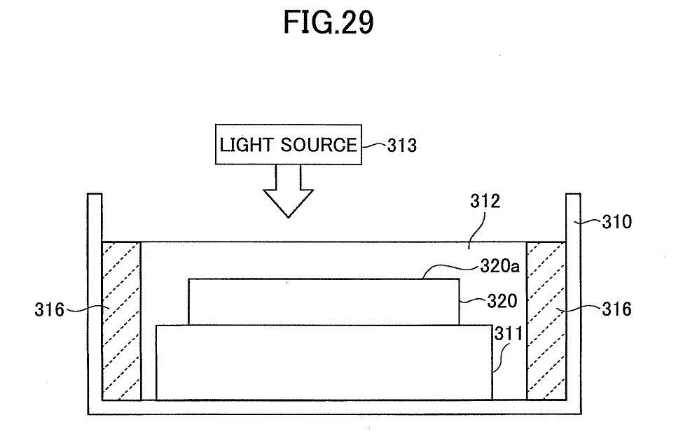

FIG. 29 is a schematic diagram illustrating a thin film manufacturing method according to an eighth embodiment of the present invention. In the eighth embodiment, a damper (absorber) 316 is provided at an inner wall surface of the reaction container 310. In this embodiment, the damper 316 is provided covering the entire inner wall surface of the reaction container 310. For example, a porous material such as a sponge may be used to form the damper 316. Further, from the aspect of dispersing shock waves, a material having a viscosity substantially equivalent to that of the metal oxide precursor solution 312 may be used to form the damper 316. More specifically, a bag or the like formed of a resin containing a solution having a viscosity equal to or more than the metal oxide precursor solution 312 may be used. In this example, the viscosity of the metal oxide precursor solution 312 is approximately 1-30 mPasec.

In a case where a wave(s) is generated at the surface of the metal oxide precursor solution 312, the laser beam irradiated from the light source 313 may diffuse and disturb the shape of the beam spot of the irradiated laser beam. In other words, such generation of a wave at the surface of the metal oxide precursor solution 312 causes difficulty in achieving accurate patterning.

Further, the generation of the wave locally changes the height of the metal oxide precursor solution 12. This changes conditions such as the depth of light transmittance and the focal point of the light. As a result, optical energy cannot be effectively applied to a target irradiation area. Further, the generation of the wave causes the surface area of the metal oxide precursor solution 312 to increase. Due to the increase of the surface area of the metal oxide precursor solution 312, the evaporation rate of the metal oxide precursor solution 312 increases. As a result, the characteristics (particularly, viscosity) of the metal oxide precursor solution 312 changes and the film forming characteristics is also changed.

However, with the eighth embodiment of the present invention in which the damper 316 is provided at the inner wall surface of the reaction container 310, waves can be absorbed (eliminated) by the damper 316. Accordingly, a high quality thin film can be manufactured.

It is to be noted that other than providing the damper 316 at the inner wall surface of the reaction container 310 in the thin film manufacturing method according to the eighth embodiment, the processes performed for forming the thin film are substantially the same as those performed in the above-described thin film manufacturing method according to the sixth and seventh embodiments.

In a modified example of the eighth embodiment, a material having high rigidity (e.g., aluminum) may be used for forming the damper 316. Further, the height and phase of the wave of the metal oxide precursor solution 312 may be detected so that the damper 316 could be driven with an opposite phase based on the detected height and phase of the wave of the metal oxide precursor solution 312. Thereby, the wave of the metal oxide precursor solution 312 can be alleviated.

The present invention is not limited to the specifically disclosed embodiments, and variations and modifications may be made without departing from the scope of the present invention.

The present application is based on Japanese Priority Application Nos. 2009-267905, 2009-267906, and 2009-267907 filed on Nov. 25, 2009, the entire contents of which are hereby incorporated herein by reference.

What is claimed is:

1. A thin film manufacturing method comprising the steps of:
a) placing a substrate including a first main surface inside a reaction container filled with a raw material solution; and
b) forming a thin film by irradiating a light in the direction of the first main surface of the substrate.

2. The thin film manufacturing method as claimed in claim 1, wherein the raw material solution is a metal oxide precursor solution, wherein the thin film is a metal oxide thin film, wherein the thin film includes a metal oxide formed on a portion of the first main surface to which the light is irradiated, and wherein the light has a wavelength equal to or more than 400 nm.

3. The thin film manufacturing method as claimed in claim 1, wherein the substrate has an electrode layer provided on the first main surface, and wherein the thin film is formed on a portion of the electrode layer to which the light is irradiated.

4. The thin film manufacturing method as claimed in claim 3, wherein the electrode layer is patterned.

5. The thin film manufacturing method as claimed in claim 3, wherein the electrode layer includes a light absorbing property.

6. The thin film manufacturing method as claimed in claim 1, wherein the substrate has a light absorbing layer provided on the first main surface, and wherein the thin film is formed on a portion of the light absorbing layer to which the light is irradiated.

7. The thin film manufacturing method as claimed in claim 6, wherein the light absorbing layer is patterned.

8. The thin film manufacturing method as claimed in claim 1, wherein the substrate further includes a second main surface being formed on a back side of the substrate opposite of the first main surface.

9. The thin film manufacturing method as claimed in claim 1, further comprising a step of:
causing the raw material solution to flow inside the reaction container.

10. The thin film manufacturing method as claimed in claim 9, wherein the substrate is positioned to be parallel to a horizontal direction of the reaction container, and wherein a motor is used to cause the raw material solution to flow parallel to the first main surface of the substrate.

11. The thin film manufacturing method as claimed in claim 9, wherein an ultrasonic generator is used to cause the flow of the raw material solution.

12. The thin film manufacturing method as claimed in claim 9, wherein the first main surface of the substrate is positioned parallel to a vertical direction of the reaction container, and wherein a motor is used to cause the raw material solution to flow in a direction opposite to gravity.

13. The thin film manufacturing method as claimed in claim 9, wherein the substrate is mounted on a pedestal including a pedestal motor, and wherein the pedestal motor is rotated to cause the flow of the raw material solution.

14. The thin film manufacturing method as claimed in claim 1, wherein the step b) includes a step of irradiating an excitation light together with the light in the direction of the first surface.

15. The thin film manufacturing method as claimed in claim 1, wherein the step b) includes a step of heating the substrate.

16. The thin film manufacturing method as claimed in claim 1, wherein a micro-heater is installed inside the substrate for heating the substrate.

17. The thin film manufacturing method as claimed in claim 1, wherein the thin film is configured to be used as at least one of an ultrasonic piezoelectric element, a non-volatile memory element, and an actuator element.
